(19) United States
(12) Patent Application Publication
(10) Pub. No.: US 2011/0231819 A1
(43) Pub. Date: Sep. 22, 2011

(54) Content Availability Determination, Representation And Acquisition System

(75) Inventors: Christopher Clark Tanner, San Jose, CA (US); Rory W. Mather, St Helena, CA (US)

(73) Assignee: Emdigo Inc.

(21) Appl. No.: 13/052,057

(22) Filed: Mar. 19, 2011

Related U.S. Application Data
(60) Provisional application No. 61/282,704, filed on Mar. 19, 2010.

(51) Int. Cl. G06F 9/44

(52) U.S. Cl. 717/123

(57) ABSTRACT

A computer implemented method and system is provided for determining availability of one or more content objects and acquiring them for a user. A content management server is provided in communication with a transaction management server via a network. A software component in communication with the content management server is provided on the user's computing device. The software component monitors characteristic information of the user. The software component and/or the content management server determine availability of the content objects for the user based on the characteristic information and context of the software component. The content management server generates a visual representation of the content objects for user access. The transaction management server initiates a delivery transaction that generates a reference pointer to each of the content objects based on the user's inputs. The user initiates actions associated with the content objects using the reference pointer for acquiring the content objects.

### CROSS REFERENCE TO RELATED APPLICATIONS

This application claims the benefit of provisional patent application No. 61/282,704 titled “Deployable identifiable widget interaction system”, filed on Mar. 19, 2010 in the United States Patent and Trademark Office.

The specification of the above referenced patent application is incorporated herein by reference in its entirety.

### BACKGROUND

Users have access to multiple different applications, digital media objects, and services via multiple mobile and internet devices. The process of acquiring content, applications, services comprising, for example, marketing services, etc., is distributed and non-standard. Moreover, users who enter information on many websites are responsible for looking out for their own privacy interests, are constantly subject to a changing process for acquiring content, applications, services, etc., and are responsible for managing relationships with each content, application or service provider. Users are often unable to identify a process to acquire content, applications, or services. Users are often unaware as to which companies are in control of their personal information that is provided as a part of the process to acquire content, applications, or services.

Efforts have been made to address these issues in certain areas, for example, distributable one-click purchase experiences from vendors, process of sharing interest in a specific website, etc. Although these methods address some issues related to user interaction on the web, there is a need for a solution that specifically allows determination and acquisition of mobile applications, content, mobile or internet marketing content streams, etc., via a centralized system that also provides user-facing management of personal information as well as centralized management of personal information. Currently a mobile application publisher uses independently designed, maintained and managed systems for tracking users and delivering digital media and applications to mobile phones. These independent systems are heterogeneous, confusing, confounding, and rarely work. Furthermore, users must provide their personal information, for example, in the form of a mobile phone number to each vendor independently even before understanding whether a service or application will be available for the user's mobile phone. Furthermore, the delivery process does not terminate in an appropriate manner, leaving users anxious about how their mobile phone numbers are used.

Hence, there is a long felt but unresolved need for a computer implemented method and system that determines availability of one or more content objects, for example, content, mobile applications, mobile or internet marketing content streams, products, services, etc., for a user and acquires the content objects for the user via a centralized system along with efficient centralized management of the user's personal information.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein addresses the above stated need for determining availability of one or more content objects for a user and acquiring the content objects for the user via a centralized system along with efficient centralized management of the user's personal information. As used herein, the term “content objects” refers to elements of content, for example, text objects, voice objects, video objects, multimedia objects, mobile applications, desktop applications, mobile or internet marketing content streams, etc., associated with applications, content, products and services. The computer implemented method and system disclosed herein connects users to individual content objects in a centralized manner and supports delivery of the content objects from any website to any computing device. The computer implemented method and system disclosed herein provides a content management server and a transaction management server. The content management server communicates with the transaction management server via a network. The content management server manages information associated with the content objects and the user via the network.

The computer implemented method and system disclosed herein provides a software component on the user's computing device. As used herein, the term “software component” refers to a deployable user-identifiable visually customized reusable element, for example, a widget that acquires content objects such as applications, content, products, services, etc., from a website or a server for the user. The software component is provided to the user, for example, via a website or via a direct installation on the user's computing device. Also, as used herein, the term “computing device” refers to a network capable uniquely identifiable networked computing device with an ability to browse the internet, for example, via hypertext markup language (HTML) browsers and wireless application protocol (WAP) browsers. The computing device is, for example, a mobile phone, a tablet computer, a personal computer, a laptop, a personal digital assistant, a gaming console, an embedded internet television, etc. The software component is in communication with the content management server via the network.

The software component monitors characteristic information of the user. As used herein, the term “characteristic information” comprises information associated with one or more user activities performed on the user's computing device and information associated with the user's computing device. The user activities performed by the user on the user's computing device comprise, for example, multiple input actions of the user, content viewing behavior of the user, links accessed by the user, content displayed on the user's computing device, and time spent by the user on the user's computing device and the network. The information associated with the user's computing device comprises, for example, the user's mobile phone number, type of mobile carrier, the mobile device manufacturer, model, technology platform, etc.

In an embodiment, one or more web components that interact with the software component are deployed on the user's computing device for monitoring the characteristic information of the user on the user's computing device. In an embodiment, the software component monitors the user's characteristic information by tracking the user across one or more websites via the network using a third party temporary file and/or a third party application. In another embodiment, the software component monitors the user's characteristic information of the user by logging the characteristic information on the user's computing device. The software component transmits the characteristic information of the user to the content management server via the network for storage on the content management server.

In an embodiment, the software component stores the characteristic information of the user in a temporary file, for example, a cookie, on the user's computing device. The characteristic information of the user is therefore stored in a temporary file on the user's computing device, on the content management server, or on both the user's computing device and the content management server. The software component can also utilize the characteristic information transiently for configuring and displaying the software component on the user's computing device. The characteristic information of the user controls the behavior of the software component when accessed by the user.

In an embodiment, the content management server, in communication with the software component, determines one or more content objects for the user based on the user's characteristic information. The content management server, in communication with the software component, identifies the user for determining the content objects and for determining the availability of the determined content objects for the user using the user's characteristic information and unique user information.

The content management server, in communication with the software component, determines availability of the content objects for the user based on the characteristic information of the user and context of the software component accessible on the user's computing device. As used herein, the term “context” of the software component refers to information related to positioning, nature, and accessibility of the software component. For example, when the software component is accessed on a website, the context of the software component comprises content of a webpage of the website containing the software component, where information on one or more content objects is presented or where information on the nature of the content objects is presented. In an embodiment, the software component automatically recognizes availability of the content objects for the user based on the user's characteristic information.

In an embodiment, the software component stores one or more parameters associated with the determination of the availability of the content objects for the user in a temporary file, for example, a cookie, on the user's computing device. The software component utilizes the temporary file, availability information stored in an availability information database in the content management server, or a combination thereof for determining the availability of the content objects for the user. The content management server also accesses the temporary file stored by the software component via the network and utilizes the characteristic information stored in the temporary file and availability information stored in the availability information database in the content management server for determining the availability of the content objects.

In an embodiment, the user's computing device directly uses the software component itself to determine availability of the content objects by combining information from the temporary file in conjunction with a file accessed from the content management server containing corresponding availability information for the user's computing device with characteristics of the user's computing device.

In an embodiment, the user's characteristic information is determined using information returned based on a hypertext transfer protocol (HTTP) request to the content management server. The content management server determines the version of the software component to return to the user's computing device based on availability of the content objects.

The content management server generates a visual representation of the content objects for the user based on the determined availability and the user's characteristic information. The visual representation of the content objects comprises a visual representation of the determined availability of the content objects for the user. In an embodiment, the generation of the visual representation of the content objects comprises creating one or more visual elements specific to the user and/or the user's computing device. As used herein, the term “visual elements” refers to one or more text objects or graphic objects that visually represent the content objects. The visual elements are, for example, selected by the user, associated with unique user information, or associated with the user's characteristic information. The generated visual representation of the content objects is displayed to the user via a graphical user interface of the software component. The user accesses the visual representation of the content objects on the software component.

The transaction management server, in communication with the content management server via the network, initiates a delivery transaction that generates a reference pointer for each of the content objects based on inputs provided by the user on accessing the visual representation. The transaction management server delivers the generated reference pointer to the user's computing device via the content management server. In an embodiment, the transaction management server initiates the delivery transaction, for example, using one or more short message code text messages.

The user initiates one or more actions associated with the content objects on the software component using the delivered reference pointer for acquiring the content objects. The user initiated actions associated with the content objects on the software component comprise, for example, purchasing the content objects, opting for the content objects, downloading the content objects, obtaining and viewing additional information on the content objects from the content management server, rating the content objects, sharing the content objects with other users, etc. The transaction management server tracks the initiated delivery transaction and associates the initiated delivery transaction with an identifier for analyzing the initiated delivery transaction, progress of the delivery of the reference pointer, sharing of the reference pointer between multiple users, the actions associated with the content objects initiated by the users, etc.

The software component displays the acquired content objects to the user on one or more interfaces of the software component configured, for example, based on the user's characteristic information, the unique user information, the visual elements selected by the user, etc. In an embodiment, the computer implemented method and system disclosed herein provides interactive access of the software component to external server applications for determining, acquiring, and displaying the content objects over the network. In an embodiment, the software component acquires marketing information associated with the content objects from multiple external sources. The software component transmits the acquired marketing information to the content management server for enabling marketing and distribution of one or more content objects to the user.

In an embodiment, the software component optimizes and customizes the experience of acquiring the content objects based on user specified characteristic information and the monitored characteristic information. The software component can be configured to deliver the content objects by a single interaction. In an embodiment, the user also customizes preferences to specify where the content objects should be acquired, purchased, or downloaded from in order to support multiple content object stores such as mobile application stores or content marketplaces rather than a single content object store and a content marketplace.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method for determining availability of one or more content objects for a user and acquiring the content objects for the user.

FIG. 2 exemplarily illustrates a computer implemented system for determining availability of one or more content objects for a user and acquiring the content objects for the user.

FIG. 3 exemplarily illustrates the architecture of a computer system employed for determining availability of one or more content objects for a user and acquiring the content objects for the user.

FIGS. 4A-4B exemplarily illustrate a flowchart comprising the steps for determining availability of one or more content objects for a user.

FIG. 5A exemplarily illustrates a flow diagram for determining characteristic information of a user.

FIG. 5B exemplarily illustrates a screenshot of a web page that provides three availability states for acquiring a content object for a user.

FIG. 6 exemplarily illustrates a screenshot of a web page containing a software component, showing a visual element appearing as a popup window displaying availability of a content object for a user's computing device.

FIG. 7 exemplarily illustrates a screenshot of a web page displaying a campaign metrics report for a marketing campaign associated with a content object.

FIG. 8 exemplarily illustrates a screenshot of a web page displaying statistical information associated with delivery of content objects to users based on the information associated with the users' computing devices.

FIG. 9 exemplarily illustrates a screenshot of a web page containing the software component, showing an inline frame requiring a user input to initiate a delivery transaction associated with a content object.

FIGS. 10A-10B exemplarily illustrate screenshots of web pages containing the software component, showing determination of availability of a content object for a user's computing device based on the user's characteristic information.

FIG. 11 exemplarily illustrates a screenshot of a web page displaying a customized visual representation generated for a content object.

### DETAILED DESCRIPTION OF THE INVENTION

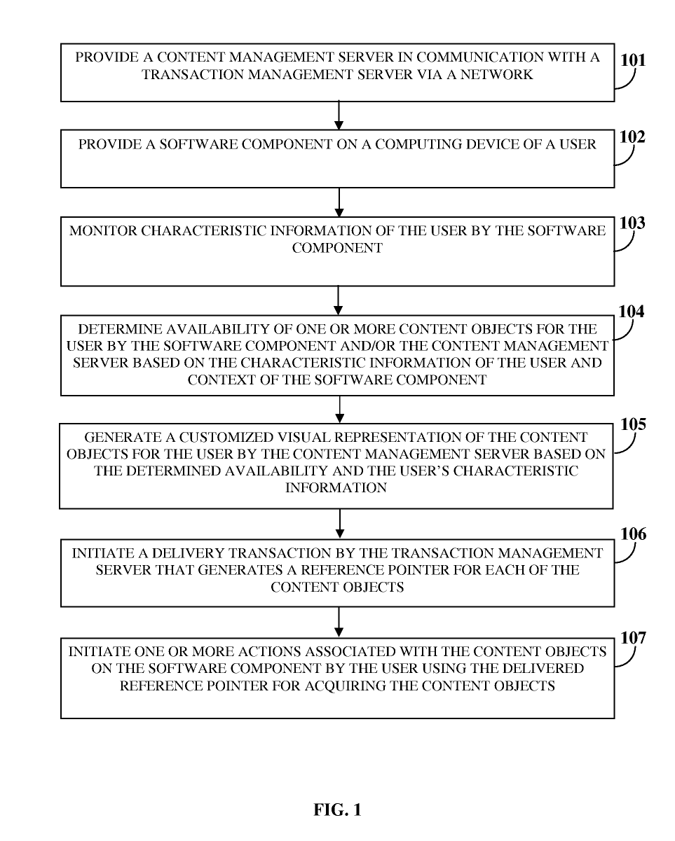

FIG. 1 illustrates a computer implemented method for determining availability of one or more content objects for a user and acquiring the content objects for the user. As used herein, the term “user” refers to a consumer who interacts with a software component of the computer implemented system disclosed herein for browsing, purchasing, or downloading content objects on a computing device. Also, as used herein, the term “content objects” refers to elements of content, for example, text objects, voice objects, video objects, multimedia objects, mobile applications, desktop applications, mobile or internet marketing content streams, etc., associated with applications, content, products and services. The computer implemented method and system disclosed herein provides 101a content management server in communication with a transaction management server via a network. The content management server manages information associated with the content objects and the user via the network. The content management server is a centralized server that stores and manages information associated with the content objects and the user via the network. In an embodiment, the computer implemented method and system disclosed herein provides a partner website for configuring the content objects on the content management server.

In an embodiment, the user registers with the content management server by entering, for example, a phone number or an electronic mail (email) address into the software component deployed on a website hosted, for example, by a web hosting server or the content management server. In another embodiment, the user registers with the content management server by creating a user account on the content management server. The content management server provides an interface, for example, a user management interface, for enabling the user to centrally control the information associated with the user account and opt-in or opt-out of receiving content objects, for example, marketing campaigns, keyword-based advertising channels, content channels, mobile application subscriptions, standalone application subscriptions, internet application subscriptions, etc. In an embodiment, users can link the user account on the content management server to the user's other accounts associated with external websites, for example, Facebook® of Facebook, Inc., Amazon® of Amazon.com, Inc, etc., and other social, retail and professional networking websites. In addition, users can automatically import information associated with external websites into the created user account and recommend content objects to other users and friends linked to the user's other accounts on the external websites. In an embodiment, the computer implemented method and system disclosed herein provides a mining server for generating and updating information, for example, marketing information, availability information, etc., associated with the content objects in a content database and an availability information database in the content management server.

The computer implemented method and system disclosed herein provides 102 a software component on a computing device of the user. As used herein, the term “software component” refers to a deployable user-identifiable visually customized reusable element, for example, a widget that acquires content objects such as applications, content, products, services, etc., from a website or a server for the user. The software component is provided to the user via a website or via a direct installation on the user's computing device. Also, as used herein, the term “computing device” refers to a network capable uniquely identifiable networked computing device with an ability to browse the internet, for example, via hypertext markup language (HTML) browsers and wireless application protocol browsers. The computing device is, for example, a mobile phone, a tablet computer, a personal computer, a laptop, a personal digital assistant, a gaming console, an embedded internet television, etc., that can be identified by a phone number, an electronic (email) address, or other device identifier or communicated to via a network connection.

In an embodiment, the software component is implemented, for example, as JavaScript. In another embodiment, the software component is implemented as a reference to an image via a uniform resource locator (URL) while being hyperlinked via the URL to the functionality of the software component. The software component can be implicit in the content of web pages or explicitly installed onto the user's computing device. The software component can be directly implemented in websites, or can be added to websites as rich media advertisements or drop-in widgets. Furthermore, the software component can be directly installed on the user's computing device. The software component is programmed in a number of languages, for example, Java, C++, Flash, JavaScript, etc. In an embodiment, the software component is implemented by executing a server based code on accessing a simple image, for example, via hypertext transfer protocol (HTTP). The software component is associated with a component identifier. The software component is in communication with the content management server via the network

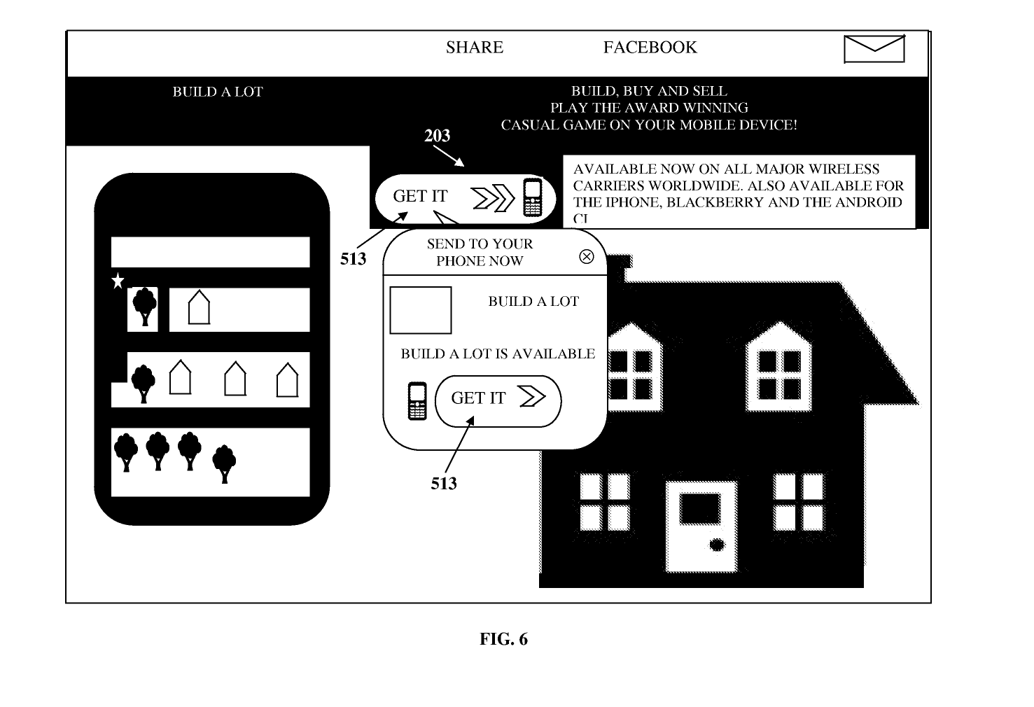

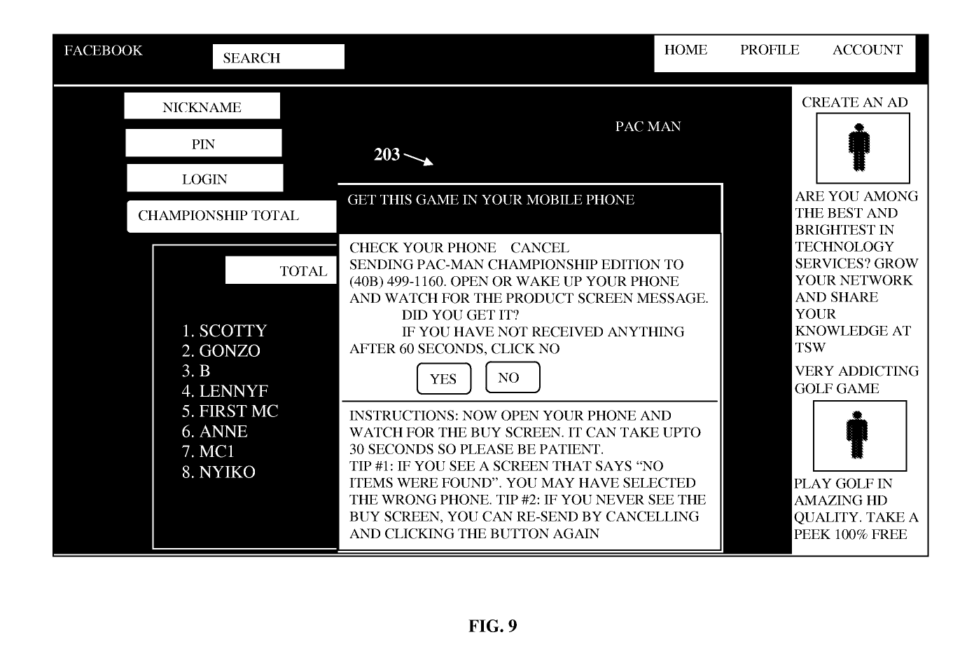

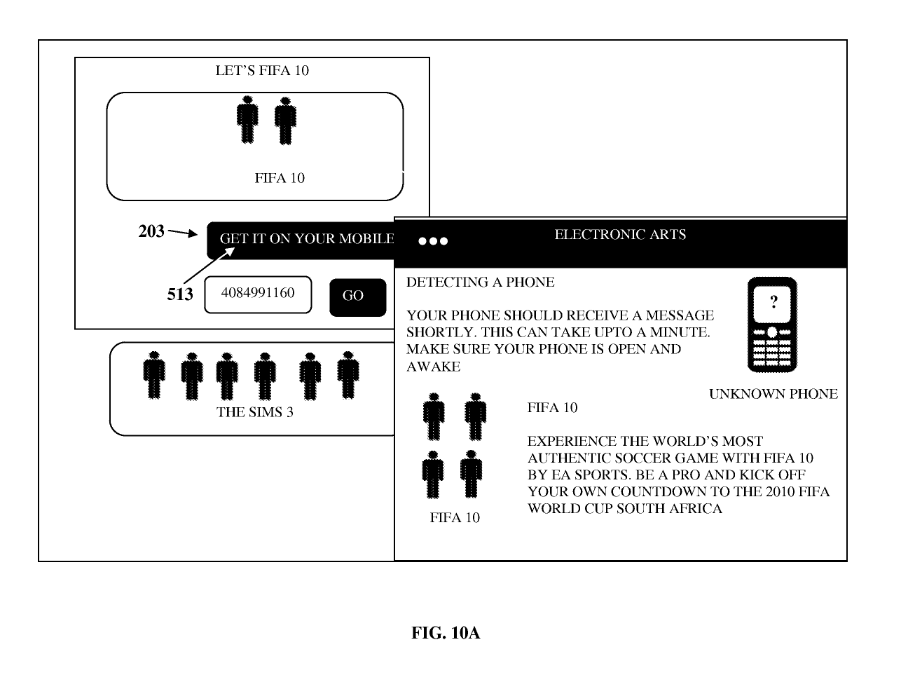

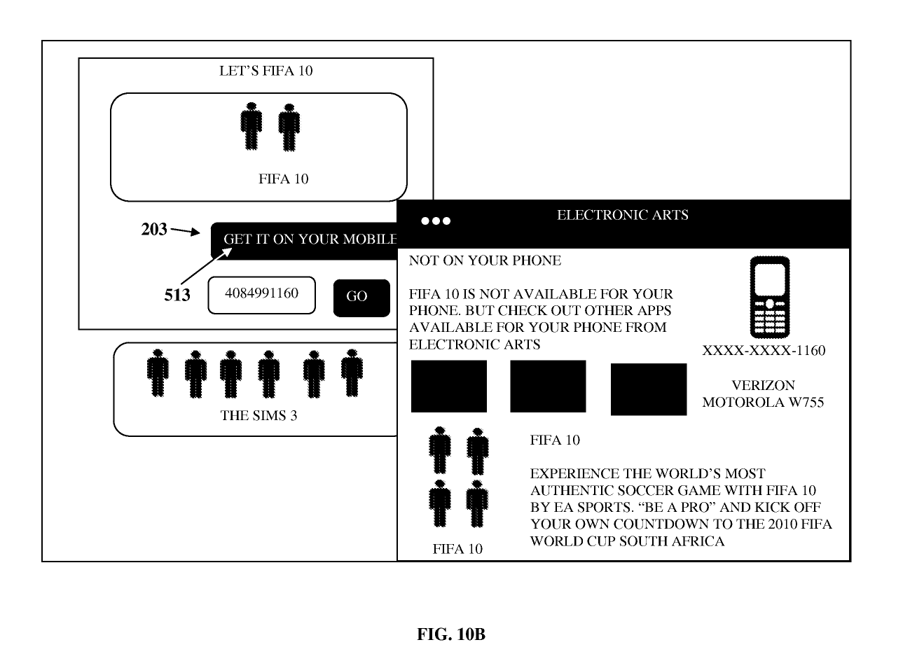

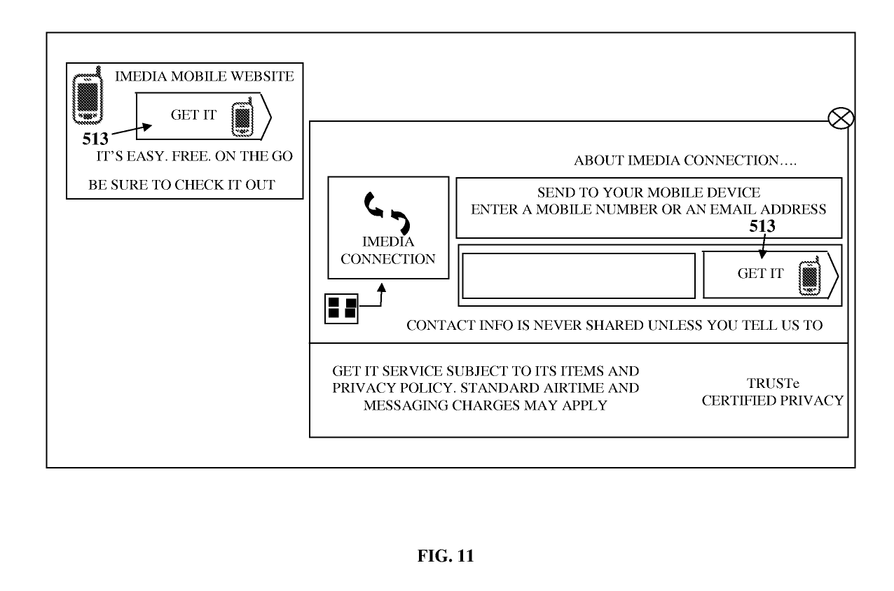

The software component comprises multiple interfaces, for example, a web interface, a graphical user interface, overlay bubbles defined in JavaScript, overlay windows, popup windows, electronic mail (email) interfaces, mobile messaging interfaces, Flash interfaces, etc., for enabling the user to interact with the software component in a scalable manner. The user interacts with the software component, for example, by clicking on a uniform resource locator (URL) displayed on the software component to initiate a transaction via a new pop-up window or an overlay with an inline frame as exemplarily illustrated in FIG. 6, FIG. 9, FIGS. 10A-10B, and FIG. 11. The content management server stores information associated with the software component, for example, assets of the software component, interactions of the user with the software component, etc. In addition, the content management server stores client applications, web applications programmed in an internet scripting language such as JavaScript, Flash® of Adobe Systems Incorporated, hypertext markup language (HTML) for web pages, etc., and other web clients.

The software component monitors 103 characteristic information of the user. As used herein, the term “characteristic information” comprises information associated with one or more user activities performed on the user's computing device and information associated with the computing device. The user activities performed by the user on the user's computing device comprise, for example, multiple input actions of the user, content viewing behavior of the user, links accessed by the user, content displayed on the user's computing device, and time spent by the user on the user's computing device and the network. The information associated with the computing device is, for example, carrier information of the user's computing device, a mobile phone number associated with the user's computing device, the device manufacturer, model, technology platform, etc. In an embodiment, the software component automatically tracks, manages, and provides links to multiple privacy policies of companies or individuals associated with the computer implemented system disclosed herein. Furthermore, the software component provides the user with a direct ability to review and manage the privacy policies via the created user account.

In an embodiment, the software component stores the user's characteristic information on the content management server and/or locally on the user's computing device. In an embodiment, the software component stores the characteristic information in a temporary file, for example, a cookie, on the user's computing device. The software component utilizes the characteristic information for configuring and displaying the software component on the user's computing device. The software component utilizes the user's characteristic information transiently to populate a graphical user interface (GUI) of the software component and to configure how the software component will act when accessed by the user.

In an embodiment, one or more web components that interact with the software component are deployed on the user's computing device for monitoring the user's characteristic information on a fine grain basis. For example, a single JavaScript function can be executed to monitor a user's activity on a web page. An identifier is associated with each user activity. The JavaScript function comprises a remote file, for example, a file defined in JavaScript. A query string associated with a request to execute the JavaScript function comprises an identifier for a web page containing the software component, an identifier for the session, an identifier for the instance, an identifier for the user's activity, and a unique identifier for the request to avoid browser caching. The JavaScript function executes as a server side script and records data passed on the query string. The JavaScript function returns data via JavaScript to the web page enabling finer grained monitoring of the user's characteristic information than the monitoring of characteristic information that is possible with web traffic logs, as in-page interaction can be monitored at any level of detail. The transaction management server tracks the fine grained monitored characteristic information and stores the tracked fine grained monitored characteristic information in a transaction database residing in the transaction management server.

In an embodiment, the software component monitors the user's characteristic information by logging the characteristic information on the user's computing device. Logging of the user's characteristic information is customized to specific web page interactions. The software component tracks, for example, specific hover and click actions of the user that remain in the web page, visibility information, time, idle and delay information including accurate web page view data, etc. The software component logs, for example, time, idle and delay information by a ping process that rings the website hosting the web page at predefined intervals without involving user interaction. In an embodiment, the software component monitors the user's characteristic information by tracking the user across one or more websites via the network using a third party temporary file and/or a third party application. The monitored characteristic information of the user over different websites can be aggregated by linking the monitored characteristic information of the user across different web pages and websites to each user. For example, third party cookies are used by advertisement networks to track a user's website visitation habits, content viewing habits, etc., over different web pages or on a single web page. The software component transmits the characteristic information to the content management server via the network for storage on the content management server.

The content management server, in communication with the software component, determines one or more content objects for the user based on the user's characteristic information. The content management server, in communication with the software component, identifies the user for determining the content objects for the user and for determining the availability of the determined content objects for the user using the user's characteristic information and unique user information. The unique user information comprises, for example, a phone number associated with the user's mobile phone, an account number of the user associated with the user account created on the content management server, a user identification number associated with the user account, and user identification numbers associated with one or more external websites. The unique user information is obtained from information associated with the user account stored on the content management server. In an embodiment, the software component is preconfigured to offer particular content objects to the user and has an ability to cross promote other content objects to the user based on availability.

In an embodiment, the content management server identifies the user, for example, by receiving an input or a message from the user, querying a content database in the content management server or a user database in the transaction management server using a user identifier stored on the user's computing device, etc. The content management server acquires the unique user information, for example, from the user's computing device, the transaction management server, and/or external marketing parties via multiple input modes, for example, from browser dialog boxes, text boxes, browser cookies, etc., and messaging modes, for example, from short message service (SMS) messages, multimedia messaging service (MMS) messages, etc. In an example, the content management server identifies the user using a mobile phone number of the user's mobile phone or a mobile device identifier used to interact with the content management server.

The software component and/or the content management server in communication with the software component determines 104 availability of the content objects for the user based on the user's characteristic information and context of the software component accessible on the user's computing device. As used herein, the term “context” of the software component refers to information related to positioning, nature, and accessibility of the software component. For example, when the software component is accessed on a website, the context of the software component comprises content of a webpage of the website containing the software component, where information on one or more content objects is presented or where information on the nature of the content objects is presented. In another example, if the webpage containing the software component presents information about the nature of the content objects, for example sports content, then the context of the software component is “sports” content.

In an embodiment, the software component stores one or more parameters associated with the determination of the availability of the content objects for the user in a temporary file, for example, a cookie, on the user's computing device. For example, the software component stores information on the user's mobile device carrier information, the user's mobile device operating system, the user's mobile device model, and the user's unique identifier in a temporary file on the user's computing device. These parameters are used in combination with a content object identifier to access availability information of the content object stored in an availability information database in the content management server for that particular mobile device. In an embodiment, accessing availability information of the content object is performed by accessing a specific file on the content management server that comprises the availability information and the corresponding delivery information for the specific content object. In another embodiment, the content management server may store one file per content object identifier. The content management server comprises an array or a flattened database that stores availability and delivery information accessible by using identification information of the mobile device as an accessor key.

In an embodiment, the software component utilizes the temporary file for determining the availability of the content objects. The software component automatically recognizes availability of the content objects for the user based on the user's characteristic information. In another embodiment, the content management server accesses the temporary file stored by the software component and utilizes the characteristic information stored in the temporary file and availability information stored in the availability information database in the content management server for determining the availability of the content objects.

In an embodiment, the user's computing device directly uses the software component itself to determine availability of the content objects by combining information from the temporary file stored by the software component in conjunction with a file accessed from the content management server containing corresponding availability information for the user's computing device with the characteristics of the user's computing device. In another embodiment, the user's characteristic information is determined using information returned based on a hypertext transfer protocol (HTTP) request to the content management server. The content management server determines the version of the software component to return to the user's computing device based on availability of the content objects.

The content management server accesses the temporary file stored by the software component via a file based access for determining the availability of the content objects. In an embodiment, the content management server, in communication with the software component, automatically determines availability of the content objects via a cross-referenced user database residing in the transaction management server. The cross-referenced user database comprises information identifying a direct or indirect ability to determine availability of the content objects for the user's computing device and/or the ability of the content management server to deliver the content objects to the user.

In an embodiment, the content management server, in communication with the software component, determines availability of the content objects in a scalable manner by factoring the availability information database residing in the content management server into a file based database. The file based database is easily accessible via websites in a scalable manner. The file based database provides views of the content objects via flattened files containing one or more attributes associated with the user account on the content management server used for determining availability. In an embodiment, the content management server, in communication with the software component, determines availability of the content objects using the content database and the availability information database residing in the content management server, and user information stored in the user database of the transaction management server, when the user loads a web page of a website. Furthermore, the content management server, in communication with the software component, allows users and partner websites to create information for storage in the availability information database for subsequent availability determination.

The content management server generates 105 a visual representation of the content objects for the user based on the determined availability and the user's characteristic information. The visual representation of the content objects for the user is customized based on the user, the content objects, and/or the state of the user's computing device. The customized visual representation of the content objects generated by the content management server allows for immediate recognition of availability and identification of the user and/or the user's computing device. In an embodiment, the visual representation of the content objects comprises a visual representation of the determined availability of the content objects for the user. In an embodiment, the content management server generates a visual representation for unidentified users to convey unknown availability.

The generation of the visual representation of the content objects comprises creating one or more visual elements specific to the user and/or the user's computing device. As used herein, the term “visual elements” refers to one or more text objects or graphic objects that visually represent the content objects and/or availability of the content objects for the user. For example, a green widget or button represents a product that is readily available, a grey widget or button represents a product that is not available, a yellow widget or button is used for representation when the user is unidentified or unknown, etc. The content management server creates graphically differentiated visual elements to represent availability of the content objects for a particular user.

The visual elements for the visual representation can be selected by the user, associated with the unique user information, or associated with the user's characteristic information. The unique user information comprising, for example, information associated with one or more accounts of the user with one or more external websites, for example, Facebook® of Facebook, Inc, Amazon® of Amazon.com, Inc, etc., is stored in the user database in the transaction management server. The content management server communicates with the transaction management server via the network to retrieve the unique user information.

In an embodiment, user identifiable customization of the generated visual representation of the content objects comprises automatically associating graphics and text, for example, an electronic mail address, a picture, etc., acquired from, for example, social networking websites associated with the user, in the visual representation. In an example, the content management server uses images to represent the user's computing device or text representing the user's mobile phone number that always appears when the user is recognized or identified. In an embodiment, specific visual elements are generated for each computing device when the software component is accessed on the user's computing device. When the software component is accessed on the user's computing device, the user's computing device is identified and an appropriate computing device image can automatically be shown along with text to directly convey identification of the user's computing device and the availability of the content objects for the user's computing device.

The content management server, in communication with the software components serves different web images to the user based on identification of the user and/or the user's computing device. The HTTP request used to retrieve the characteristic information of the user from the content management server comprises sufficient information for determining device and screen parameters, availability of the content objects, etc., to return an image or other visual elements that directly convey the identification of the user and/or the user's computing device to the software component. For example, an image-based advertisement is displayed on the user's computing device based on identification of the user and the user's computing device.

In an embodiment, the content management server, in communication with the software component, customizes the visual elements of the generated visual representation of the content objects, for example, based on a combination of text stored in a temporary file such as a browser cookie and associated generic visual assets, for example, graphics and text, referred to in the temporary file and stored on the network. Information in the temporary file is specific to a user and is parameterized. Since the information in the temporary file is parameterized, the generic visual assets are maintained on the content management server and the network. The generic visual assets can be used in combination to create a user identifiable composite visual element for the software component.

Consider an example where a mobile phone identifier along with the last four digits of the mobile phone number is stored in the temporary file. A customized visual element is created on a directly accessible image of the mobile phone based on the mobile phone identifier stored in the temporary file and rendered to the user's mobile phone. In an embodiment, the content management server, in communication with the software component, processes the generic visual assets via tools provided to one or more publishing partners to make the generic visual assets suitable for easy integration into a single button or multiple buttons or different styles associated with the software component, thereby providing a visually identifiable and visually appealing experience to the user.

In an embodiment, computing device parameterization is generated from a browser of the user's computing device that accesses the software component. As used herein, the term “device parameterization” refers to defining parameters for the user's computing device. The parameters are, for example, an extensible markup language (XML) profile of the user's computing device comprising characteristic information of the user's computing device such as screen size, operating system type, version, browser capabilities and the user's computing device ability to playback media formats such as advanced audio coding (AAC) audio or third generation partnership project (3GP) video. In an embodiment, device parameterization is directly accessed via extra HTTP parameters such as a user agent profile. In another embodiment, additional parameters can be used to uniquely identify the user's computing device characteristics via a lookup in, for example, the availability information database based on pattern matching of regular expressions with the HTTP parameters. For example, a Blackberry mobile device of Research in Motion Ltd. directly references an XML file via HTTP in a user agent profile parameter on every HTTP access.

The content management server, in communication with the software component, provides a publishing mechanism for deploying characteristic information associated with the user on a network of file based databases in the content management server or on the network, allowing the characteristic information associated with the user to be fetched efficiently for viewing multiple times on web pages. The visual representation of the content objects is displayed to the user via the software component. The user accesses the visual representation of the content objects via a graphical user interface (GUI) of the software component.

The transaction management server, in communication with the content management server, initiates 106 a delivery transaction that generates a reference pointer or a lead for each of the content objects based on inputs provided by the user on accessing the visual representation. As used herein, the term “reference pointer” refers, for example, to a wireless application protocol (WAP) link, a referral uniform resource locator (URL), a content object store hyperlink, a content object-directed short message service (SMS) used to directly interact with a content object storefront, or an internet hyperlink defined via a hypertext markup language (HTML) and interpreted by an internet browser, for example, a web browser such as Internet Explorer® of Microsoft Corporation, Firefox® of Mozilla Corporation, etc., that retrieves, displays, and allows exchange of content resources on the world wide web. Also, as used herein, the term “content object-directed SMS” refers to a message sent to the user's computing device such as a mobile phone via a mobile carrier's short message service and directed to a particular content object or service on the mobile phone. The application-directed SMS messages may or may not be seen by the user as part of an SMS interface.

The transaction management server delivers the generated reference pointer to the user's computing device via the content management server. The reference pointer is delivered by recognizing the user's computing device inline and redirecting the reference pointer to the recognized computing device. The delivery transaction spans multiple computing devices and multiple content objects.

The transaction management server initiates the delivery transaction, for example, using short message code text messages. The transaction management server associates the delivery transaction with a specific user in the user database. For example, the user sends a short message code text message, for example, “geiko” to a number, for example, 69074. The short message code text message queries the transaction management server or the content management server for information associated with the user. The content management server then signs up the user to receive marketing information from the company, for example, Geiko insurance. The content management server uses personal information of the user, for example, a mobile phone number of the user, to validate if the user has already opted for the marketing information from Geiko insurance. If the user has not opted for the marketing information, the content management server interacts with the user via a short message code text message to attempt to validate the user and setup an account for receiving the marketing information from Geiko insurance. In an embodiment, the content management server or the transaction management server automatically asks the user to opt-in for future marketing information associated with the content objects on completing a transaction. Furthermore, the software component redirects the user to other websites after completion of the delivery transaction.

The user initiates 107 one or more actions associated with the content objects on the software component using the delivered reference pointer for acquiring the content objects. The user initiated actions associated with the content objects on the software component comprise, for example, purchasing the content objects, opting for the content objects, downloading the content objects, obtaining and viewing additional information on the content objects from the content management server, rating the content objects, sharing the content objects with one or more other users, etc. In an embodiment, the software component provides one or more web interfaces for executing the delivery of the reference pointer and the user initiated actions over the web interfaces via one or more scripted transactions. The scripted transactions are stored in a transaction database residing in the transaction management server. In an embodiment, the user can obtain additional information on the content objects in a scalable manner by interacting with the content database, which is a flattened file database of the content objects in the content management server over the network.

The transaction management server tracks the initiated delivery transaction and associates the initiated delivery transaction with an identifier for analyzing the initiated delivery transaction, progress of the delivery of the reference pointer, sharing of the reference point between multiple users, and one or more actions associated with the content objects initiated by the users. The transaction management server initiates and tracks transactions initiated from other media, for example, print, billboard, radio, television advertisement media, etc. The transaction management server tracks the software component using a component identifier of the software component and an associated campaign identifier.

The transaction management server provides a state identifier and one or more transaction parameters to enable the software component to start a delivery transaction in a specific state of user interaction. For example, when the user clicks on a uniform resource locator (URL) comprising an identifier associated with a content object and a mobile phone number, an inline frame encapsulated software component is provided to the user for determining the availability of and acquiring the content object for which the delivery transaction has been initiated. The inline frame tracks the status of the progress of the delivery transaction. The transaction management server tracks information associated with the user and associates the tracked information with the user. The transaction management server provides the user with metrics associated with the tracked information.

The reference pointer delivered to the user's computing device comprises state and transaction identifiers allowing the transaction management server to track progress on the initiating web-based interface and on the user's computing device. As the user moves through a transactional script, each reference pointer will have a modified state and transaction parameters. Therefore, the computer implemented method and system disclosed herein directs the user through complex transactional scripts and tracks the reference pointer's progress.

In an embodiment, sharing of the reference pointer between users can also be implemented and tracked via changes to the URL. In this embodiment, the transaction management server tracks the origin of the shared reference pointer or the URL and creates user metrics for influence or branching factors. The transaction management server identifies information about a URL every time a URL is accessed. For example, the transaction management server identifies from where the URL came and whether the URL is a shared URL or a directly accessed URL. If the URL is a shared URL, the transaction management server maintains a graph structure depicting the sequence of users who shared the URL. The transaction management server assigns a weighting factor to each edge in the graph structure based on the number of shared nodes and uses the weighting factor to compute a metric for how influential any single user has been ultimately in the sharing of the URL. In another embodiment, a branching factor metric is displayed directly within the software component when a user has shared a reference pointer using the software component.

The transaction management server directly tracks metrics related to user behavior, for example, branching factors, net growth factor, failed reference pointers generated, and branches terminated due to non-supported computing devices during interaction with the computer implemented system disclosed herein and is therefore able to provide direct metrics relative to a marketing campaign. The tracked metrics further comprise, for example, ratio of available versus unavailable content object requests, sell through and send through rates based in a marketing channel and campaign tags, overall popularity of a device manufacturer, a model, a carrier, a device platform, etc., the percentage of users unable to complete transactions, the percentage of users who accessed a campaign's software component from a mobile device, etc. The transaction management server stores the tracked metrics in the transaction database. The transaction management server provides publishers and providers of the content objects with the tracked metrics to facilitate marketing of the content objects.

The software component displays the acquired content objects to the user on one or more interfaces of the software component configured based on the user's characteristic information, the unique user information, and/or the visual elements selected by the user. In an embodiment, the software component displays the acquired content objects via the GUI using built-in programming techniques of a browser application on the user's computing device.

In an embodiment, the software component optimizes and customizes the experience of acquiring content objects based on user specified characteristic information and the monitored characteristic information. The software component can be configured to deliver content objects by a single interaction, for example, a single click action from the user. In another embodiment, the user also customizes preferences to specify where the content objects should be acquired, purchased, or downloaded from in order to support multiple content object stores such as mobile application stores or content marketplaces rather than a single content object store and a content marketplace.

In an embodiment, the computer implemented method disclosed herein provides interactive access of the software component to external server applications for determining, acquiring, and displaying the content objects over the network. The software component uses, for example, JavaScript to load one or more additional scripts onto an already loaded web page via a specialized programming technique for developing external applications. This programming technique allows loading of the additional scripts from websites other than the loaded web page's host website. This programming technique comprises inclusion of state information in a request to retrieve the additional scripts, dynamic generation of resulting programming code for retrieving and loading the additional scripts on the web page containing the software component, and building of insertable in-page functional code.

The software component includes the state information by passing the state information to the content management server via a third party temporary file such as a cookie or using a query string via a script based request. For dynamic generation of the resulting programming code, the content management server parses the temporary file or the query string in response to the request and generates a script appropriate to one or more parameters and context of the software component, thereby facilitating a dynamic client-server interaction using JavaScript. Consider an example where an inline JavaScript based software component is used on a Sims3 brand web page. In case the user of the web page is already a user of the system disclosed herein, a cookie identifying the user is passed along with a unique application identifier for the Sims3 mobile game to the content management server. The content management server then dynamically assembles generic assets for the user's mobile device, the sims3 application, and visual elements such as a green button, a yellow button or a red button to convey direct availability of the Sims3 mobile application for the user's mobile device. Furthermore, the content management server generates a custom interface based on the user's stored preferences to facilitate delivery of the reference pointer in an optimum manner for the user. In other examples of an unknown user, the JavaScript and images are customized based on the context of the interaction on the web page and knowledge about the user's computing device accessing the web page.

A server other than the content management server can effectively communicate back to the web page without ever loading another web page. The dynamic generation of the resulting programming code occurs continuously with any frequency based on a network used for communication. Building of insertable in-page functional code enables third party interaction with the content management server. Applications designed using the insertable in-page functional code can be deployed on any server. The programming technique enables a class of JavaScript based web components that are completely standalone and robust and can be dropped onto a web page.

In an embodiment, the content management server delivers the content objects to the user. In another embodiment, the content management server delivers URLs or other reference pointer links to a download website or a web page for the content objects. In an embodiment, the software component acquires marketing information associated with the content objects from multiple external sources. The software component transmits the acquired marketing information to the content management server for enabling marketing and distribution of the content objects to the user. The content management server interacts with partner websites that provide a marketing interface for creating marketing campaigns for the content objects based on information tracked by the transaction management server. The partner websites can create new tracked campaigns with real-time or near real metrics provided by the transaction management server. The content management server, in communication with the software component, allows the provider of the content objects to launch one or more marketing campaigns to target users who have opted to receive marketing campaigns. In an embodiment, the content management server in communication with the software component, allows the provider of the content objects to automatically use a content object as an add-on, a feature or an alternative to another content object when the content object is not available.

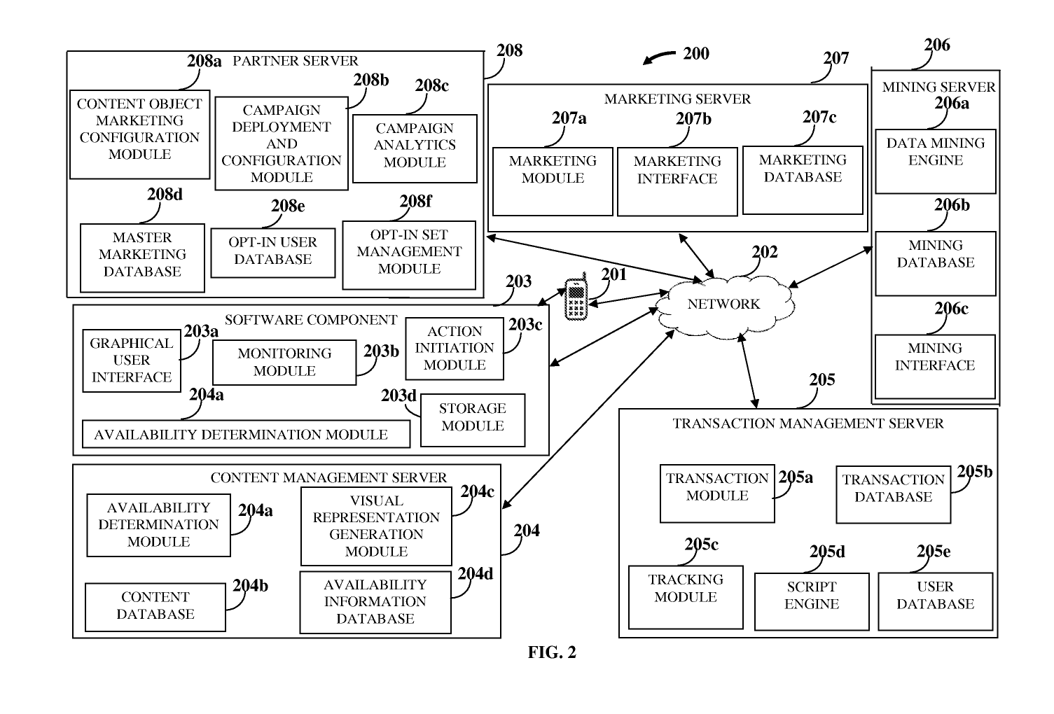

FIG. 2 exemplarily illustrates a computer implemented system 200 for determining availability of one or more content objects for a user and acquiring the content objects for the user. The computer implemented system 200 disclosed herein comprises a content management server 204 in communication with a transaction management server 205, a marketing server 207, a mining server 206, and a partner server 208 via a network 202. The computer implemented system 200 disclosed herein further comprises a software component 203 in communication with the content management server 204 via the network 202. The software component 203 is accessed via a website or directly installed on the user's computing device 201. The software component 203 comprises a graphical user interface (GUI) 203a, a monitoring module 203b, a storage module 203d, and an action initiation module 203c. The monitoring module 203b monitors the user's characteristic information comprising information associated with one or more user activities performed on the user's computing device 201 and information associated with the user's computing device 201. The user activities are, for example, multiple input actions of the user, content viewing behavior of the user, links accessed by the user, content displayed on the user's computing device 201, and time spent by user on the user's computing device 201 and the network 202. The information associated with the user's computing device 201 comprises, for example, carrier information of the user's computing device 201, a mobile phone number associated with the user's computing device 201, etc. The storage module 203d stores the characteristic information of the user and one or more parameters associated with the determination of the availability of the content objects for the user in a temporary file on the user's computing device 201.

The content management server 204 communicates with the software component 203 via the network 202. The content management server 204, in communication with the software component 203, determines content objects based on the context and configuration of the software component 203, the user's characteristic information, for example, information associated with one or more user activities on the user's computing device 201 and information associated with the user's computing device 201. The content management server 204 comprises an availability information database 204d, a content database 204b, and a visual representation generation module 204c. The availability information database 204d stores, for example, availability information of multiple content objects, device support information, mobile carrier support information, device platform support information, the user's characteristic information, etc. For purposes of illustration, the detailed description refers to a single availability information database 204d; however, the scope of the computer implemented method and system 200 disclosed herein may be extended to include a network of databases for independent storage of availability information of multiple content objects, device support information, mobile carrier support information, device platform support information, etc.

The computer implemented system 200 disclosed herein further comprises an availability determination module 204a on the software component 203 and/or the content management server 204. The availability determination module 204a determines availability of the content objects for the user based on the user's characteristic information, the context and configuration of the software component 203, and availability information of the content objects stored in the availability information database 204d. In an embodiment, the availability determination module 204a of the software component 203 utilizes the temporary file comprising the monitored characteristic information for determining the availability of the content objects for the user. In another embodiment, the availability determination module 204a of the software component 203 determines availability of the content objects by combining information from the temporary file stored by the software component 203 in conjunction with a file accessed from the content database 204b of the content management server 204 containing corresponding availability information for the user's computing device 201 with the characteristics of the user's computing device 201.

In another embodiment, the availability determination module 204a of the content management server 204 accesses the temporary file stored by the software component 203 for determining the availability of the content objects. The availability determination module 204a of the content management server 204 determines the availability of the content objects by indexing the content database 204b, for example, using content object identifiers, and the user's characteristic information. In another embodiment, the availability determination module 204a of the content management server 204 accesses the temporary file stored by the software component 203 via the network 202 and utilizes the characteristic information stored in the temporary file and availability information stored in the availability information database 204d in the content management server 204 for determining the availability of the content objects.

The content database 204b is a relational database of information necessary to deliver the reference pointer to the content objects to the user's computing device 201. The content database 204b stores the user's characteristic information, information associated with the content objects, information on interactions with the content objects, marketing information from one or more websites, etc. The content database 204b also stores device support information, mobile carrier support information, device platform support information, content object pricing information, and content object carrier product identifiers, content object identifiers, etc. The content database 204b also stores the content object delivery information comprising, for example, sets of instructions for delivering the content objects to the user's computing device 201. Each of the instructions comprises, for example, delivery uniform resource locators (URLs). For purposes of illustration, the detailed description refers to a single content database 204b; however, the scope of the computer implemented method and system 200 disclosed herein may be extended to include a network of databases for independent storage of user information, the user's computing device information, the user's characteristic information, the user's computing device platform information, content objects, content object determination and acquisition information, content object distribution stock keeping unit (SKU) information, content object marketing information, etc.

In an embodiment, the content database 204b comprises a lookup table from where a combination of a computing device identifier and a content object identifier is used to retrieve a content record comprising an optional URL from the content database 204b. The combination of the computing device identifier and the content object identifier and the combination of the characteristic information and the content object identifier enable prioritization by the availability determination module 204a when determining availability of a content object.

The visual representation generation module 204c of the content management server 204 generates a visual representation of the content objects for the user based on the determined availability and the user's characteristic information. The visual representation generation module 204c creates one or more visual elements specific to the user and/or the user's computing device 201 for the generation of the visual representation of the content objects, where the visual elements are selected by the user, associated with unique user information, and/or associated with the characteristic information. The user accesses the visual representation on the software component 203. The GUI 203a of the software component 203 allows the user to interact with the software component 203. The GUI 203a displays the generated visual representation and the acquired content objects to the user. The GUI 203a of the software component 203 is configured based on the characteristic information of the user, unique user information, and/or visual elements selected by the user. The GUI 203a and other interfaces, for example, 206c, 207a, etc., of the computer implemented method disclosed herein are optimized to allow users to obtain additional information about the content objects in a scalable manner via interaction with a file based flattened database 204b of content objects.

The transaction management server 205 communicates with the content management server 204 via the network 202. The transaction management server 205 comprises a transaction module 205a, a transaction database 205b, a tracking module 205c, a script engine 205d, and a user database 205e. The transaction module 205a initiates a delivery transaction that generates a reference pointer for each of the content objects based on inputs provided by the user on accessing the generated visual representation. The transaction module 205a delivers the generated reference pointer to the user's computing device 201 via the content management server 204 for enabling the user to acquire the content objects. The action initiation module 203c of the software component 203 enables the user to initiate one or more actions associated with the content objects on the software component 203 using the delivered reference pointer for acquiring the content objects. The GUI 203a of the software component 203 displays the acquired content objects to the user.

The tracking module 205c of the transaction management server 205 tracks the initiated delivery transaction and associates the delivery transaction with an identifier. The tracking module 205c tracks the progress of delivery of the reference pointer and one or more actions associated with the content objects initiated by the users for analyzing the initiated delivery transaction, progress of delivery of the reference pointer, sharing of the reference pointer between multiple users, etc. The transaction database 205b stores information obtained from the tracking module 205c and one or more transaction scripts associated with acquiring the content objects for a user on the transaction management server 205. The transaction database 205b is a relational database of different transaction scripts and records of executions of these transaction scripts. The transaction database 205b also stores information that is used to determine which transaction scripts can be used for determining availability of the content objects for the user's computing device 201 and for acquiring the content objects for the user based on the user's characteristic information and context of the software component 203 accessible on the user's computing device 201. The tracking module 205c records fine grain tracking metrics for developing the transaction scripts stored in the transaction database 205b. For purposes of illustration, the detailed description refers to a single transaction database 205b; however, the scope of the computer implemented method and system 200 disclosed herein may be extended to include a network of databases for independent storage of transaction information, transaction scripts, transaction identifiers, pointers assigned to each of the transactions associated with the content objects to track purchase of the content objects by the user, etc.

The script engine 205d executes transaction scripts involved in generation of the reference pointer, the delivery of the content objects, etc. In an embodiment, the script engine 205d also executes transaction scripts for each of the content objects based on inputs provided by the user involving the marketing of the content objects to the user. Different scripts are stored into a database of transaction scripts as a part of the transaction database 205b. The user database 205e of the transaction management server 205 stores information on sets of users grouped under specific criteria based on the user's characteristic information.

Each transaction script is designed to complete a particular system marketing task or delivery task to a certain type of computing device 201 on a certain mobile carrier or network. Transaction scripts can be written in scripting languages, for example, LUA, Python, or custom scripting languages. Transaction scripts represent flow through a state machine associated with each complete user-related process, for example, purchasing a content object such as a mobile application. Transaction scripts can also be put in wait states waiting for an action to complete, for example, an action of waiting for a user to click on a reference pointer. The transaction management server 205 has the ability to use the information of the user's computing device 201 to index the transaction database 205b of transaction scripts for a specific type of interaction. For example, when delivering a content object to an AT&T phone, a transaction script is used that first sends a reference pointer and accounts for the potential that the AT&T phone is able to exclusively use WAP push messages or normal SMS when accessing content links. Alternative transaction scripts can be bound or conditional process shortening can be achieved inside a transaction script when a user and/or the computing device 201 are known.

The marketing server 207 comprises a marketing module 207a, a marketing database 207c, and a marketing interface 207b. The marketing database 207c stores marketing information associated with one or more content objects. The marketing information comprises, for example, tracked and analyzed actions, information obtained from tracking performed by the transaction management server 205, inputs from a user, and information on the content management server 204. The marketing module 207a, in communication with the partner server 208 via the network 202, initiates marketing of one or more content objects. The marketing module 207a, in communication with the software component 203 via the network 202, acquires marketing information associated with the content objects from multiple external sources for marketing and distributing the content objects to the user.

The marketing interface 207b receives input from the user for initiating marketing of the content objects. Users interact with the marketing interface 207b in order to initiate different marketing actions. In general, the marketing interface 207b contains a generated server code to serve user interactions with the system 200. The marketing interface 207b is a generated code based on templates for web interaction on and off device for each type of user interaction. These templates comprise, for example, templates for requesting a user's mobile phone number, opt-in screens, etc., displaying product information, giving the users instructions for upcoming on-device interactions, displaying related content objects, requesting feedback on a content object, displaying content object information in the form of product pages, etc. These templates are stored in the master marketing database 208d on the partner server 208, filled in via the content management server 204, and published to the marketing server 207. Automated processes are used to facilitate the generation and publishing of marketing content and interface to the marketing database 207c and the marketing interface 207b of the marketing server 207 based on changes to the master marketing database 208d on the partner server 208 and/or time.

In an embodiment, the marketing interface 207b is used by users of the partner server 208 to cause the marketing module 207a to iterate over lists of opted-in users to perform marketing tasks. In this case as with individual instantiated user interactions, the marketing module 207a communicates with the transaction module 205a of the transaction management server 205 via the network 202 to initiate a transaction script on the transaction management server 205 directly or indirectly to perform a given marketing task such as sending an SMS marketing message, marketing a newly available content object from a publishing partner from whom the user has previously opted in to receive future marketing, etc.

The marketing database 207c is a relational database that stores marketing information relevant to the content objects. The marketing database 207c stores, for example, one or more identifiers for the content objects, marketing images of the content objects, sample versions of the content objects, videos, user or editorial reviews, text description of the content objects, etc. For purposes of illustration, the detailed description refers to a single marketing database 207c; however, the scope of the computer implemented method and system 200 disclosed herein may be extended to include a network of databases for independent storage of marketing information such as content object identifiers, marketing images of the content objects, sample versions of the content objects, videos, user or editorial reviews, text description of the content objects transaction information, marketing aliases including short codes, etc.

The mining server 206 comprises a data mining engine 206a, a mining database 206b, and a mining interface 206c. The data mining engine 206a implements internet scraping technology to analyze multiple on-device and online application interfaces to generate and update the content database 204b on the content management server 204 for storing information related to one or more content objects. The data mining engine 206a generates and updates the content database 204b in the content management server 204 via the network 202 with the user's characteristic information, information associated with the content objects, information on interactions with the content objects, marketing information from one or more websites, etc. The content database 204b stores preferences associated with the content objects received from the user for allowing the transaction module 205a on the transaction management server 205 to generate the reference pointer to each of the content objects. The data mining engine 206a builds its version of the content database 204b in the mining database 206b to support multiple computing device platforms and mobile carriers. In an embodiment, the mining database 206b and the content database 204b are the same database. The data mining engine 206a mimics multiple application interfaces and browsers on the computing device 201 to precisely determine the availability of the content objects, pricing of the content objects, marketing of the content objects, and determination and acquisition information. In an embodiment, the data mining engine 206a generates and updates the availability information database 204d on the content management server 204 for storing availability information of the content objects.

The data mining engine 206a comprises a scheduler that scrapes WAP or web content object storefronts interactively based on priorities of manufactures, models, and the content objects of the computing device 201. The scheduler is controlled via the mining interface 206c. The mining interface 206c also allows for direct control of mining operations, inspection of the mining database 206b and mining processes, as well as the ability to manually insert sets of content object availability determination and acquisition information into the mining database 206b based on selection of one or more content objects being targeted for a set of computing devices 201 specified by combinations of device properties and device carrier information. The mining interface 206c also directs the updating of the content database 204b and the availability information database 204d based on updates in the mining database 206b. The mining interface 206c provides differing granularities of updating based on mobile carrier, device information, and the completeness of the mining operation. The mining interface 206c also allows for updating of an alias, a phone or a computing device 201, and content object information in the mining database 206b.

In an embodiment, the transaction management server 205 explicitly sets the user's priorities or determines the user's priorities based on the transaction information and usage statistics. In an embodiment, priorities are tracked in the mining database 206b itself and updated via the mining interface 206c which can be accessed via the partner server 208. The data mining engine 206a uses alias information of the content objects stored in the mining database 206b and databases of content object storefronts for parsing pertinent marketing, distribution, and aliasing information for the content objects. The data mining engine 206a crawls and scrapes the databases of the mobile carriers and the content object storefronts for content object distribution and marketing information. The data mining engine 206a can be deployed on multiple computer servers, where each of the computer servers run asynchronously and mine specific content object storefronts. The data mining engine 206a deployed on multiple computer servers requires network access on mobile carriers when applicable.

The partner server 208 initiates marketing of one or more content objects based on the stored marketing information. The partner server 208 comprises a content object marketing configuration module 208a, a campaign deployment and configuration module 208b, a campaign analytics module 208c, a master marketing database 208d, an opt-in user database 208e, and an opt-in set management module 208f. The content object marketing configuration module 208a allows partners to add and configure marketing information for configuring new content objects. The content object marketing configuration module 208a also allows users of the partner server 208 to associate content object aliases that bind content object determination and acquisition information in the master marketing database 208d to a specific content object containing many different product SKUs for different combinations of content objects and the computing devices 201.

The campaign deployment and configuration module 208b enables launching content object marketing campaigns for different marketing venues and provides the users with web links, web clients, etc., for example, JavaScript, or short code/keyword or quick response (QR) code graphics that users of the partner server 208 use to market their content objects in a given venue. The campaign analytics module 208c analyzes tracked marketing campaigns and transactional data related to a given marketing deployment. The campaign deployment and configuration module 208b creates new tracked campaigns with real time or near real time metrics for each deployment. The opt-in set management module 208f allows users of the partner websites to create working sets of opted-in users by mining the user database 205e on the transaction management server 205 for opted-in users who have opted into future marketing during a related marketing campaign. The opt-in user database 208e stores information on the sets of opted-in users as abstract references in the user database 205e.

In an embodiment, the partner server 208 is used to setup custom messaging, scripts, and HTML displayed on the user's computing device 201 when accessing the reference pointer. In another embodiment, custom HTML and follow-up messages are used to initiate sharing of the reference pointer with other users. Sharing the reference pointer is performed, for example, by selecting contacts from an on-device interface, a social networking website interface or by directly inputting contact information such as another user's mobile phone number or email address on the software component 203.

The mining server 206 is used to generate and update the content database 204b and the availability information database 204d used throughout the computer implemented system 200 disclosed herein with either automatic or manually added content object availability determination and acquisition information. The partner server 208 is used to update content marketing information to start content object marketing campaigns, which are then published to the marketing server 207, and to allow for the analysis of those campaigns.

The computer implemented system 200 disclosed herein also performs database flattening for the mining database 206b, the content database 204b, the availability information database 204d, the transaction database 205b, the user database 205e, the marketing database 207c, etc. In this context, database flattening involves the removal of conditional checking when accessing one of the databases, for example, 206b, 204b, 204d, 205b, 205e, 207c, etc., by changing the database format to be accessible via a simple indexing scheme rather than a complicated search query. Databases that have simple and known accessors can be flattened, for example, by using their accessing keys as a computer file system file and directory names and encoding the looked up value inside of the file. For example, content object availability of a given content on a given computing device 201 can be represented by encoding the content object identifier as a directory name. In each file system directory for a content object, exists a list of other directories where each directory is named for a supported computing device 201. Incoming requests for content objects or availability can be handled by the formation of a file system and file name based on a simple string concatenation rather than via a MySQL or Oracle database query. The computer implemented system 200 disclosed herein uses this concept to be able to separate out front-end components that require heavy server interaction such as marketing client queries on application availability.

Database flattening allows use of a computer's file system to directly access records or tables of the databases, for example, 206b, 204b, 204d, 205b, 205e, 207c, etc., without other software. For example, consider the MySQL database where each record consists of a name of a content object and a list of computing devices 201 in which a content application is to run. In the computer implemented method and system 200 disclosed herein, an equivalent set of files are created on the computer where there is one file for each content object that contains a text list of computing device names.

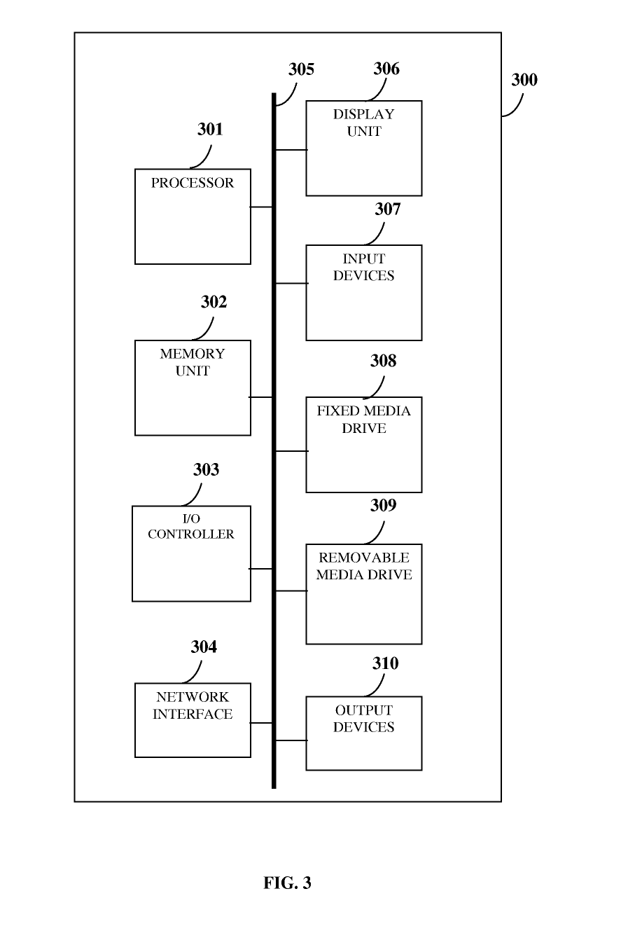

FIG. 3 exemplarily illustrates the architecture of a computer system 300 employed for determining availability of one or more content objects for a user and acquiring the content objects for the user. Each of the content management server 204, the transaction management server 205, the marketing server 207, the mining server 206, the partner server 208, and the software component 203 employs the architecture of the computer system 300 exemplarily illustrated in FIG. 3.

The content management server 204 communicates with the transaction management server 205, the marketing server 207, the partner server 208, the mining server 206, and the software component 203 via a network 202, for example, a short range network or a long range network. The network 202 is, for example, a local area network (LAN), a wide area network, a mobile communication network, etc. The computer system 300 comprises, for example, a processor 301, a memory unit 302 for storing programs and data, an input/output (I/O) controller 303, a network interface 304, a data bus 305, a display unit 306, input devices 307, a fixed media drive 308, a removable media drive 309 for receiving removable media, and output devices 310.

The processor 301 is an electronic circuit that can execute computer programs. The memory unit 302 is used for storing programs, applications, and data. For example, the modules of the content management server 204, the transaction management server 205, the mining server 206, the marketing server 207, the partner server 208, and the software component 203 are stored on the memory unit 302 of each respective computer system 300. The memory unit 302 is, for example, a random access memory (RAM) or another type of dynamic storage device that stores information and instructions for execution by the processor 301. The memory unit 302 also stores temporary variables and other intermediate information used during execution of the instructions by the processor 301. The computer system 300 further comprises a read only memory (ROM) or another type of static storage device that stores static information and instructions for the processor 301. The network interface 304 enables connection of the computer system 300 of each of the content management server 204, the transaction management server 205, the mining server 206, the marketing server 207, the partner server 208, and the software component 203 to the network 202. The computer system 300 communicates with other computer systems through the network interface 304. The network interface 304 is, for example, an infrared (IR) interface, a WiFi interface, a universal serial bus interface (USB), a local area network (LAN) interface, a wide area network (WAN) interface, etc.

The I/O controller 303 controls the input and output actions performed by the user. The data bus 305 permits communication between the modules, for example, 203a, 203b, 203c, 204a, and 203d of the software component 203. The data bus 305 permits communication between the modules, for example, 204a, 204b, 204c, and 204d of the content management server 204. The data bus 305 permits communication between the modules, for example, 205a, 205b, 205c, 205d, and 205e of the transaction management server 205. The data bus 305 permits communication between the modules, for example, 207a, 207b, and 207c of the marketing server 207. The data bus 305 permits communication between the modules, for example, 206a, 206b, and 206c of the mining server 206. The data bus 305 also permits communication between the modules, for example, 208a, 208b, 208c, 208d, 208e, and 208f of the partner server 208.

The display unit 306 displays, via the GUI 203a, the results computed by the content management server 204, the transaction management server 205, and the software component 203 to the user. The display unit 306 displays, via the marketing interface 207b, the results computed by the marketing server 207 and the partner server 208 to the user. The input devices 307 are used for inputting data into the computer system 300. The input devices 307 are, for example, a keyboard such as an alphanumeric keyboard, a joystick, a mouse, a touch pad, a light pen, etc. The output devices 310 output the results of the actions computed by the content management server 204, the transaction management server 205, the mining server 206, the marketing server 207, and the partner server 208, for example, to respective administrators. The output devices 310 output the results of the actions computed by the software component 203 to the user.

Computer applications and programs are used for operating the computer system 300. The programs are loaded onto the fixed media drive 308 and into the memory unit 302 of the computer system 300 via the removable media drive 309. In an embodiment, the computer applications and programs may be loaded directly through the network 202. Computer applications and programs are executed by double clicking a related icon displayed on the display unit 306 using one of the input devices 307. The user interacts with the computer implemented system 200 disclosed herein using, for example, the GUI 203a and the marketing interface 207b provided on the user's computing device 201. The GUI 203a and the marketing interface 207b are hosted on the software component 203 and the marketing server 207 respectively. In an embodiment, the marketing interface 207b may be plugged-in to the user's computing device 201.

The computer system 300 employs operating systems for performing multiple tasks. An operating system is responsible for the management and coordination of activities and the sharing of the resources of the computer system 300. The operating system further manages security of the computer system 300, peripheral devices connected to the computer system 300, and network connections. The operating system employed on the computer system 300 recognizes, for example, inputs provided by the user using one of the input devices 307, the output display, files and directories stored locally on the fixed media drive 308, etc. The operating system on the computer system 300 of the computing device 201 executes different programs initiated by the user using the processor 301.

Each respective processor 301 retrieves instructions for executing the modules 203a, 203b, 203c, 204a, and 203d of the software component 203, the modules 204a, 204b, 204c, and 204d of the content management server 204, the modules 205a, 205b, 205c, 205d, and 205e of the transaction management server 205, the modules 207a, 207b, and 207c of the marketing server 207, the modules 206a, 206b, and 206c of the mining server 206, and the modules 208a, 208b, 208c, 208d, 208e, and 208f of the partner server 208 from the respective program memory in the form of signals. A program counter determines the location of the instructions in the program memory. The program counter stores a number that identifies the current position in the program of each of the modules 203a, 203b, 203c, 204a, and 203d of the software component 203, the modules 204a, 204b, 204c, and 204d of the content management server 204, the modules 205a, 205b, 205c, 205d, and 205e of the transaction management server 205, the modules 207a, 207b, and 207c of the marketing server 207, the modules 206a, 206b, and 206c of the mining server 206, and the modules 208a, 208b, 208c, 208d, 208e, and 208f of the partner server 208.

The instructions fetched by the processor 301 from the program memory after being processed are decoded. After processing and decoding, the processor 301 executes the instructions. For example, the monitoring module 203b of the software component 203 defines instructions for monitoring the user's characteristic information comprising information associated with one or more user activities performed on the user's computing device 201 and information associated with the computing device 201. The storage module 203d of the software component 203 defines instructions for storing the user's characteristic information and one or more parameters associated with the determination of the availability of the content objects for the user in a temporary file on the user's computing device 201, where the temporary file is utilized by the software component 203 and the content management server 204 for determining the availability of the content objects for the user. The availability determination module 204a of the software component 203 and the content management server 204 defines instructions for determining availability of the content objects for the user based on the user's characteristic information and context of the software component 203 accessible on the user's computing device 201.

The visual representation generation module 204c of the content management server 204 defines instructions for generating a visual representation of the content objects for the user based on the determined availability and the user's characteristic information. The visual representation generation module 204c defines instructions for creating one or more visual elements specific to the user and/or the user's computing device 201 for the generation of the visual representation of the content objects, where the visual elements are selected by the user, associated with unique user information, and/or associated with the characteristic information. The GUI 203a of the software component 203 defines instructions for displaying the generated visual representation and the acquired content objects to the user.

The transaction module 205a of the transaction management server 205 defines instructions for initiating a delivery transaction that generates a reference pointer for each of the content objects based on inputs provided by the user on accessing the visual representation. The tracking module 205c defines instructions for tracking the initiated delivery transaction and associating the initiated delivery transaction with an identifier for tracking and analyzing the initiated delivery transaction, progress of delivery of the reference pointer, sharing of the reference pointer between multiple users, and one or more actions associated with the content objects initiated by the users. The script engine 205d defines instructions for executing transaction scripts involved in the generation of the reference pointers, transaction scripts involved in the delivery of the content objects, and transaction scripts involving the marketing of a content object to a user. The action initiation module 203c of the software component 203 defines instructions for enabling the user to initiate one or more actions associated with each of the content objects using the reference pointer for acquiring the content objects.

The marketing module 207a of the marketing server 207 defines instructions for acquiring marketing information associated with the content objects from multiple external sources in communication with the software component 203 for marketing and distributing the content objects to the user. The marketing interface 207b defines instructions for enabling a user to provide user input to initiate marketing of the content objects.

The data mining engine 206a of the mining server 206 defines instructions for using internet scraping technology to analyze multiple on-device and online application interfaces to generate and update the content database 204b and the availability information database 204d on the content management server 204 for storing information related to one or more content objects. The mining interface 206c of the mining server 206 defines instructions for directing the updating of the content database 204b and the availability information database 204d based on updates in the mining database 206b.

The content object marketing configuration module 208a of the partner server 208 defines instructions for allowing partners to add and configure marketing information for the content objects. The campaign deployment and configuration module 208b of the partner server 208 defines instructions for enabling launching of content object marketing campaigns for different marketing venues. The campaign analytics module 208c of the partner server 208 defines instructions for analyzing transactional data related to a given marketing deployment. The opt-in set management module 208f of the partner server 208 defines instructions for allowing users of the partner websites to create working sets of opted-in users. The defined instructions are stored in the program memory or received from a remote server.

The processor 301 of the software component 203 retrieves the instructions defined by the monitoring module 203b, the storage module 203d, the availability determination module 204a, the action initiation module 203c, and the GUI 203a and executes the instructions. The processor 301 of the content management server 204 retrieves the instructions defined by the availability determination module 204a and the visual representation generation module 204c and executes the instructions. The processor 301 of the transaction management server 205 retrieves the instructions defined by the transaction module 205a, the tracking module 205c, and the script engine 205d and executes the instructions. The processor 301 of the marketing server 207 retrieves the instructions defined by the marketing module 207a and the marketing interface 207b and executes the instructions. The processor 301 of the mining server 206 retrieves the instructions defined by the data mining engine 206a and the mining interface 206c and executes the instructions. The processor 301 of the partner server 208 retrieves the instructions defined by the content object marketing configuration module 208a, the campaign deployment and configuration module 208b, the campaign analytics module 208c, and the opt-in set management module 208f, and executes the instructions.

At the time of execution, the instructions stored in the instruction register are examined to determine the operations to be performed. The operations include arithmetic and logic operations. The processor 301 then performs the specified operation. Each respective operating system performs multiple routines for performing a number of tasks required to assign the input devices 307, the output devices 310, and memory for execution of the modules, for example, 203a, 203b, 203c, 204a, and 203d of the software component 203, the modules 204a, 204b, 204c, and 204d of the content management server 204, the modules 205a, 205b, 205c, 205d, and 205e of the transaction management server 205, the modules 207a, 207b, and 207c of the marketing server 207, the modules 206a, 206b, and 206c of the mining server 206, and the modules 208a, 208b, 208c, 208d, 208e, and 208f of the partner server 208. The tasks performed by the operating system comprise assigning memory to the modules of the computer implemented system 200 and data, moving data between the memory unit 302 and disk units, and handling input/output operations. The operating system performs the tasks, on request, by the operations and after performing the tasks, the operating system transfers the execution control back to the processor 301. The processor 301 continues the execution to obtain one or more outputs. The outputs of the execution of the modules of the computer implemented system 200 are displayed to the user and administrators.

Disclosed herein is also a computer program product comprising computer executable instructions embodied in a non-transitory computer readable storage medium. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 301, except for a transitory, propagating signal.

The computer program product disclosed herein comprises multiple computer program codes for determining availability of one or more content objects for a user and acquiring the content objects for the user. For example, the computer program product disclosed herein comprises a first computer program code for providing the software component 203 on the user's computing device 201 in communication with the content management server 204 and the transaction management server 205 via the network 202; a second computer program code for monitoring the user's characteristic information comprising information associated with one or more user activities performed on the user's computing device 201 and information associated with the computing device 201; a third computer program code for determining availability of one or more content objects for the user by the software component 203 and/or the content management server 204 in communication with the software component 203 based on the user's characteristic information and context of the software component 203 accessible on the user's computing device 201; a fourth computer program code for displaying a visual representation of the content objects generated by the content management server 204 for the user based on the determined availability and the user's characteristic information, where the user provides inputs on accessing the visual representation to initiate a delivery transaction by the transaction management server 205, in communication with the content management server 204, to generate a reference pointer for each of the content objects; and a fifth computer program code for enabling the user to initiate one or more actions associated with the content objects using the generated reference pointer delivered to the user's computing device 201 via the content management server 204 for acquiring the content objects. The computer program product disclosed herein further comprises additional computer program codes for performing additional steps that may be required and contemplated for determining availability of one or more content objects for the user and acquiring the content objects for the user.

The computer program codes comprising the computer executable instructions are embodied on the non-transitory computer readable storage medium. The processor 301 of the computer system 300 retrieves these computer executable instructions and executes them. When the computer executable instructions are executed by the processor 301, the computer executable instructions cause the processor 301 to perform the method steps for determining availability of one or more content objects for the user and acquiring the content objects for the user. In an embodiment, a single piece of computer program code comprising computer executable instructions performs one or more steps of the computer implemented method disclosed herein for determining availability of one or more content objects for the user and acquiring the content objects for the user.

For purposes of illustration, the detailed description refers to each of the servers, for example, 204, 205, 206, 207, and 208 being run locally on a computer system 300; however the scope of the computer implemented method and system 200 disclosed herein is not limited to the servers, for example, 204, 205, 206, 207, and 208 being run locally on the computer system 300 via the operating system and the processor 301 but may be extended to run remotely over the network 202, for example, by employing a web browser and a remote server, a mobile phone, or other electronic devices. The servers, for example, 204, 205, 206, 207, and 208 of the computer implemented system 200 disclosed herein support distribution of assets for passive viewing of composited information via the software component 203 and also support transaction based user interactions where the user initiates, for example, delivery of the reference pointers to the content objects, purchase, opt-in, content object delivery, registration, etc.

The computer implemented system 200 disclosed herein provides a direct ability to create new entries in the databases, for example, the content database 204b, the availability information database 204d, the transaction database 205b, the user database 205e, the marketing database 207c, the mining database 206b, the master marketing database 208d, and the opt-in user database 208e.

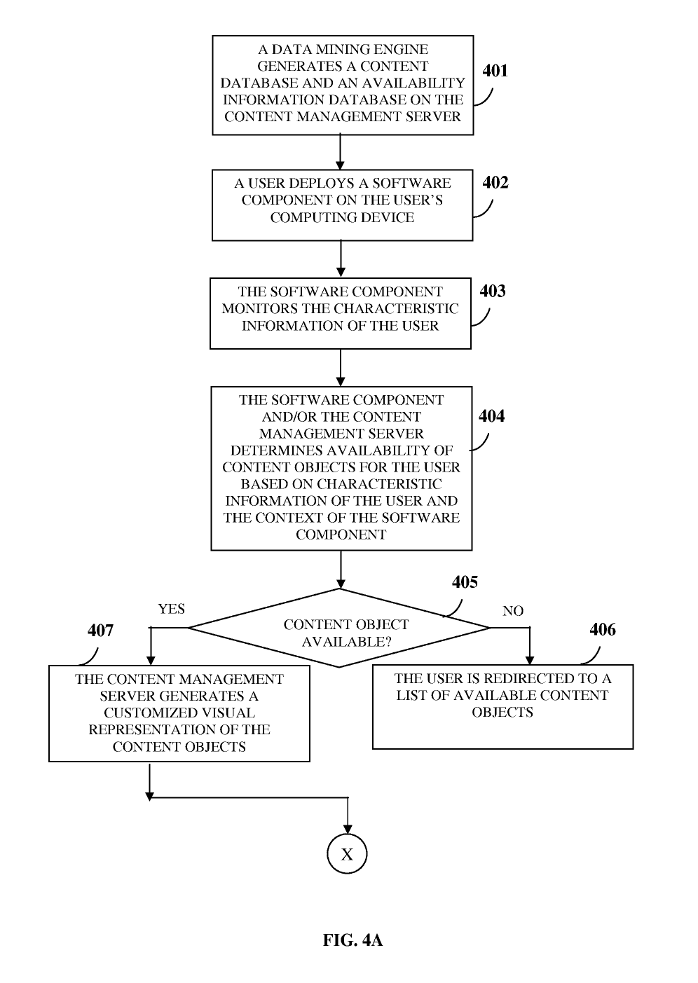

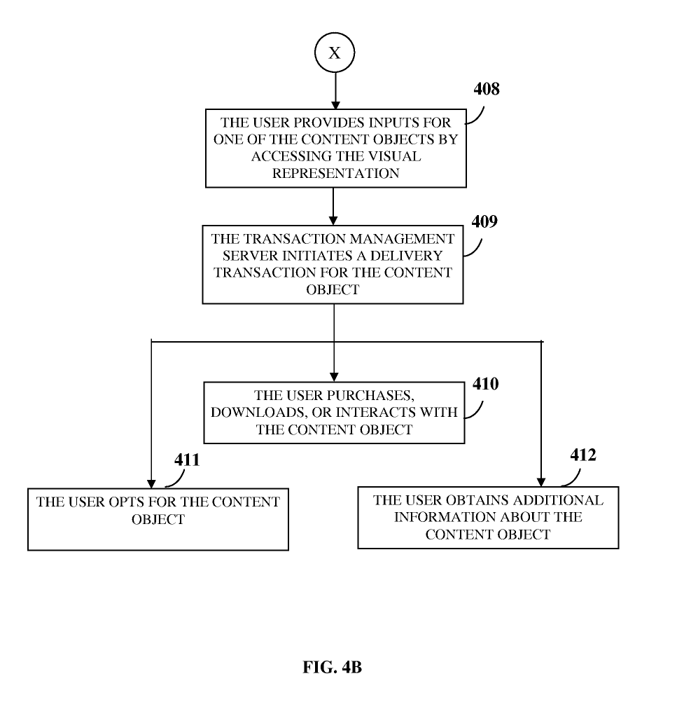

FIGS. 4A-4B exemplarily illustrate a flowchart comprising the steps for determining availability of one or more content objects for a user. A data mining engine 206a generates 401 the content database 204b and the availability information database 204d on the content management server 204. A user deploys 402 the software component 203 on the user's computing device 201, for example, via a website or via a direct installation of the software component 203 on the user's computing device 201. The software component 203 monitors 403 the user's characteristic information. The software component 203 and/or the content management server 204 determines 404 the availability of the content objects, for example, mobile application games, for the user based on the software component's 203 context and configuration and the user's characteristic information using the content database 204b and the availability information database 204d. In an embodiment, the user's computing device 201 directly uses the software component 203 itself to determine availability of the content objects by combining information from a temporary file stored by the software component 203 in conjunction with a file accessed from the content management server 204 containing corresponding availability information for the user's computing device 201 with characteristics of the user's computing device 201.

The content management server 204 checks 405 whether the content objects are available. If the content objects are unavailable, the user is redirected 406 to a list of available content objects. If the content objects are available, the content management server 204 generates 407 a customized visual representation of the content objects allowing for immediate recognition of availability and knowledge of the user and the user's computing device 201. The user provides 408 inputs for one of the content objects by accessing the visual representation. The transaction management server 205 initiates 409 a delivery transaction for the content object that generates a reference pointer to the content object. The content management server 204 delivers the generated reference pointer to the user's computing device 201. The user accesses the delivered reference pointer, for example, to purchase, download, or interact 410 with the content object, opt 411 for the content object, or obtain 412 additional information about the content object.

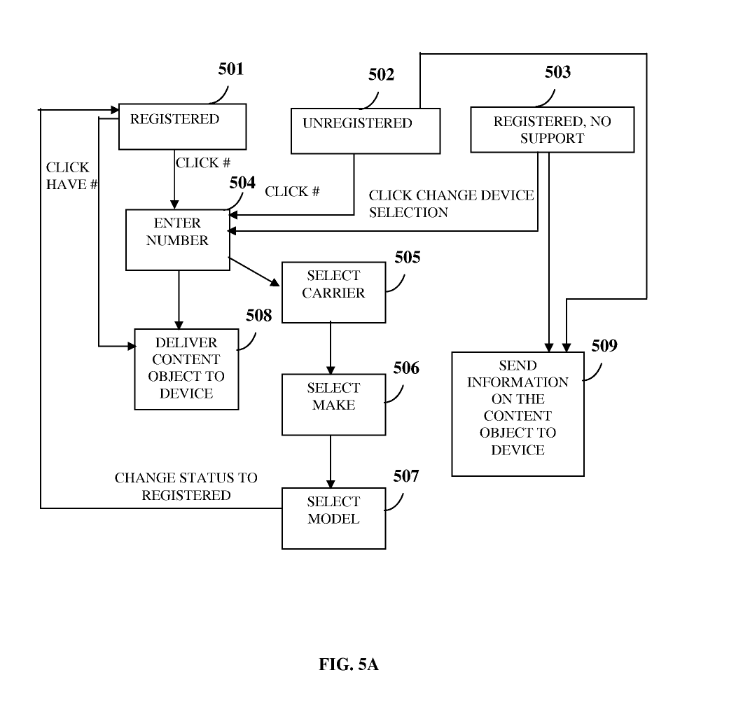

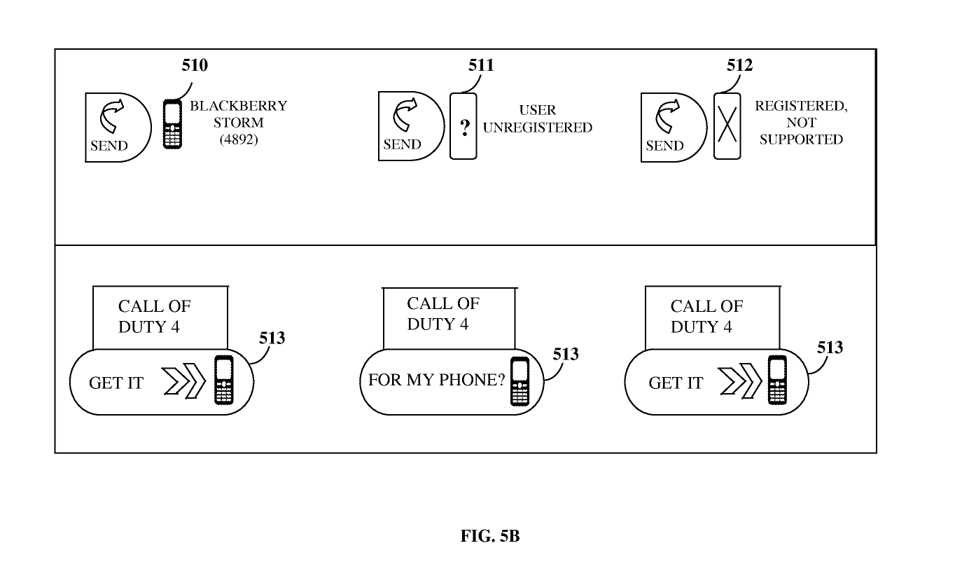

FIG. 5A exemplarily illustrates a flow diagram for determining the user's characteristic information. If the user is a registered user 501 and the content management server 204 has the user's mobile phone number of the user's computing device 201, the content management server 204 delivers 508 the content object, for example, an animation, to the user's computing device 201. If the user is a registered user 501 and the content management server 204 does not have the user's mobile phone number, then the user is requested to enter 504 the user's mobile phone number. The user selects the mobile carrier 505, the make 506 of the computing device 201, and the model 507 of the computing device 201. In an embodiment, the make of the user's computing device 201, the model of the user's computing device 201 and the mobile carrier are automatically determined after entering the mobile phone number of the user's computing device 201. In another embodiment, the software component 203 determines the user's computing device 201 information automatically if the software component 203 is being viewed directly on the web browser of the user's computing device 201. In an embodiment, the content management server 204 utilizes the user's mobile phone number for determining whether the user is a registered user 501. If the user is an unregistered user 502, the content management server 204 interacts with the user, for example, via short code messaging to attempt to validate the user and set up a user account on the content management server 204.

On determining the user's computing device information, for example, the mobile phone number, the mobile carrier, the make, the model, etc., the content management server 204 determines availability of the content object for the user's computing device 201 and generates a customized visual representation of the availability of the content object for the registered user 501. The content management server 204 then delivers 508 the content object to the user's computing device 201, if the content object is available. If the user is an unregistered user 502, the user is requested to enter 504 the user's mobile phone number and select the mobile carrier 505, the make 506 of the computing device 201, and the model 507 of the computing device 201. On receiving the selected information from the unregistered user 502, the content management server 204 changes the status of the user to a registered user 501 in the content management server 204. The content management server 204 then determines availability of the content object for the registered user 501 and delivers 508 the content object to the user's computing device 201 or sends 509 information on the content object to the user's computing device 201, if the content object is available.

If the user is a registered user, but the content object is not supported 503 on the user's computing device 201, then the user is requested to change the selection of the computing device 201. The user is requested to enter 504 the mobile phone number of the selected computing device 201 and select the mobile carrier 505, the make 506, and the model 507 of the user's selected computing device 201. The content management server 204 then determines availability of the content object for the selected computing device 201 and delivers 508 the content object to the user's selected computing device 201 or sends 509 information on the content object to the user's selected computing device 201 if the content object is available.

FIG. 5B exemplarily illustrates a screenshot of a web page that provides three availability states for acquiring a content object for a user. The three availability states are represented by three different visual elements 510, 511, and 512 of a customized visual representation generated for the user. The three visual elements 510, 511, and 512 as exemplarily illustrated in FIG. 5B represent a registered user 501 where the user's computing device 201 supports the content object, an unregistered user 502, and a registered user where the user's computing device 201 does not support 503 the content object respectively as disclosed in the detailed description of FIG. 5A. The visual element 510 for the registered user 501 displays, for example, an image of the detected computing device 201 and the last four digits of the mobile phone number of the user's computing device 201 that supports the content object. Each of the visual elements 510, 511, and 512 is associated with a “get it” button 513 which when accessed by the user via a single click initiates delivery of the content object to the user by initiation of a delivery transaction that generates a reference pointer to the content object. The “get it” button 513 can directly redirect users to other websites after specific transactions are completed.

FIG. 6 exemplarily illustrates a screenshot of a web page containing the software component 203, showing a visual element appearing as a popup window displaying availability of a content object for a user's computing device 201. The visual element displays additional information on a content object, for example, a mobile application, as a popup overlay on the web page displaying information on the mobile application. The visual element provides information associated with availability of the content object and a reference pointer to acquire the content object. The information associated with the availability of the content object and the reference pointer to acquire the content object is assembled by a client side script, for example, a script defined in JavaScript, using information stored in a temporary file, for example, a cookie, by the software component 203 and/or by accessing a simple flattened database 204d of assets and availability information on the content management server 204. When the user clicks on the reference pointer to acquire the content object, the transaction management server 205 initiates a delivery transaction for delivery of the content object to the user's computing device 201.

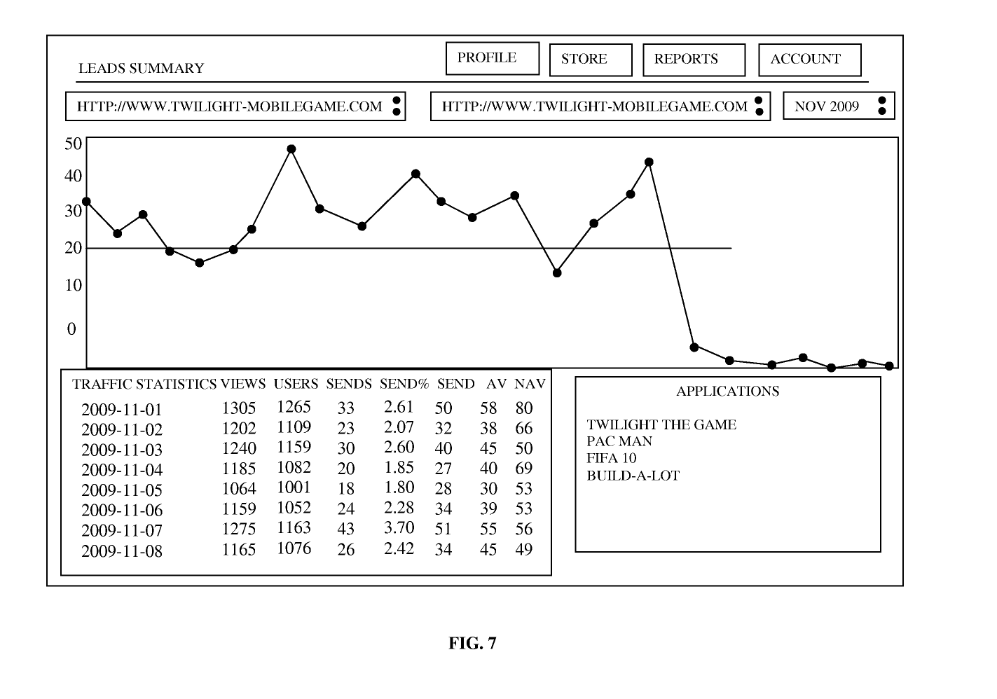

FIG. 7 exemplarily illustrates a screenshot of a campaign metrics report for a marketing campaign associated with a content object. The web page as exemplarily illustrated in FIG. 7 displays marketing information associated with the number of views of the web page displaying the content objects and the software component 203, the number of unique users accessing the web page displaying the content objects and the software component 203, the number of content objects delivered to the computing devices 201 of the unique users, the percentage of content objects delivered to the computing devices 201 of the users based on the number of unique users visiting the web page displaying the content objects, the average number of content objects delivered to the computing devices 201 of the unique users over a periodic interval of time, etc. The marketing information also comprises information associated with cross-sales, for example, marketing of a content object leading to the delivery of a related content object. The marketing information is displayed, for example, in a graphical form and a tabular form in the campaign metrics report.

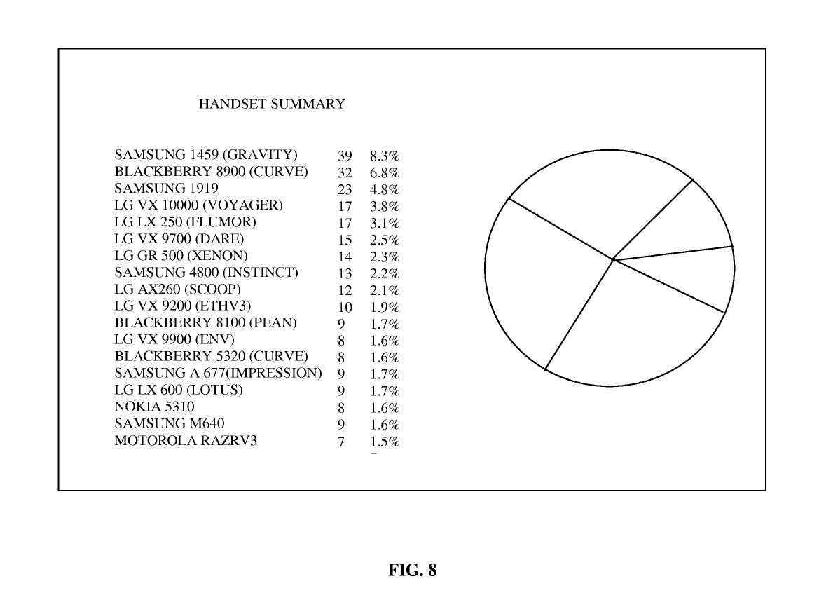

FIG. 8 exemplarily illustrates a screenshot of a web page displaying statistical information associated with delivery of content objects to users based on the information associated with the users' computing devices 201. The web page as exemplarily illustrated in FIG. 8 displays a pie chart representing the market share of each of the mobile carriers in combination with the models of the users' computing devices 201 based on the number of content objects delivered to the computing devices 201.

FIG. 9 exemplarily illustrates a screenshot of a web page containing the software component 203, displaying an inline frame requiring a user input to initiate a delivery transaction associated with a content object. The web page as exemplarily illustrated in FIG. 9 illustrates launching the inline frame via a reference pointer, for example, a HTML link, within an external source, for example, a social networking website to initiate a delivery transaction and distribute a content object from the web page of the external source.

FIGS. 10A-10B exemplarily illustrate screenshots of web pages containing the software component 203, showing determination of availability of a content object for a user's computing device 201 based on the user's characteristic information. The web page displays initiation of a delivery transaction associated with a content object inside a popup window based on a user input and cross selling the content object using the software component 203. The software component 203 attempts to detect the user's computing device 201 and determines availability of the content object for the user's detected computing device 201 as exemplarily illustrated in FIG. 10A. In an embodiment, the content management server 204 in communication with the software component 203 determines availability of the content object for the user's detected computing device 201. The user then enters the mobile phone number of the user's computing device 201 into a web form on the web page in a web banner advertisement and initiates a delivery transaction for acquiring the content object from the web page. On determining unavailability of the content object for the user as exemplarily illustrated in FIG. 10B, the software component 203 attempts to cross sell a related content object to the user by displaying reference pointers for each of the associated content objects using the software component 203.

FIG. 11 exemplarily illustrates a screenshot of a web page displaying a customized visual representation generated for a content object. For example, a “get it” button 513 is provided on the left side of the web page directing a user to an iMedia mobile website. When the user clicks on the “get it” button 513 on the web page, a pop up window is displayed on the web page showing information on the content object along with an image of an icon for iMedia. On determining availability of the content object for the user's computing device 201, the webpage enables a user to enter the user's mobile phone number to acquire the content object on the user's computing device 201. When the user clicks the “get it” button 513, a delivery transaction is initiated to distribute the content object from the web page of the iMedia mobile website to the user.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes the main memory. Volatile media comprise, for example, a register memory, processor cache, a random access memory (RAM), etc. Transmission media comprise, for example, coaxial cables, copper wire and fiber optics, including the wires that constitute a system bus coupled to a processor. Common forms of computer readable media comprise, for example, a floppy disk, a flexible disk, hard disk, magnetic tape, any other magnetic medium, a compact disc-read only memory (CD-ROM), digital versatile disc (DVD), any other optical medium, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors or like devices. Typically, a processor receives instructions from a memory or like device, and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Thus, embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as an object code. The computer program product disclosed herein comprises computer executable instructions embodied in a non-transitory computer readable storage medium, wherein the computer program product comprises computer program codes for implementing the processes of various embodiments.

Where databases are described such as the content database 204b, the availability information database 204d, the transaction database 205b, the user database 205e, the marketing database 207c, the mining database 206b, the master marketing database 208d, and the opt-in user database 208e, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes, such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are updates to the data in one of the databases.

The present invention can be configured to work in a network environment including a computer that is in communication, via a communications network, with one or more devices. The computer may communicate with the devices directly or indirectly, via a wired or wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, Sun® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

We claim:

1. A computer implemented method for determining availability of one or more content objects for a user and acquiring said one or more content objects for said user, comprising:
providing a content management server in communication with a transaction management server via a network, wherein said content management server manages information associated with said one or more content objects and said user via said network;
providing a software component on a computing device of said user, wherein said software component is in communication with said content management server via said network;
monitoring characteristic information of said user by said software component, wherein said characteristic information of said user comprises information associated with one or more user activities performed on said computing device of said user and information associated with said computing device;
determining availability of said one or more content objects for said user by one or more of said software component and said content management server in communication with said software component, based on said characteristic information of said user and context of said software component accessible on said computing device of said user;
generating a visual representation of said one or more content objects for said user by said content management server based on said determined availability and said characteristic information of said user, wherein said user accesses said visual representation on said software component;
initiating a delivery transaction by said transaction management server, in communication with said content management server, that generates a reference pointer for each of said one or more content objects based on inputs provided by said user on accessing said visual representation, wherein said generated reference pointer is delivered to said computing device of said user via said content management server; and
initiating one or more actions associated with said one or more content objects on said software component by said user using said delivered reference pointer for acquiring said one or more content objects.

2. The computer implemented method of claim 1, further comprising storing said characteristic information of said user on one or more of said content management server and a temporary file on said computing device of said user.

3. The computer implemented method of claim 1, wherein said characteristic information of said user is utilized for configuring and displaying said software component on said computing device of said user.

4. The computer implemented method of claim 1, further comprising identifying said user by said content management server, in communication with said software component, for determining said one or more content objects for said user and for said determination of said availability of said determined one or more content objects for said user using said characteristic information of said user and unique user information.

5. The computer implemented method of claim 1, wherein said availability of said one or more content objects is determined using availability information and said characteristic information of said user stored in one or more of a temporary file on said computing device of said user and said content management server.

6. The computer implemented method of claim 1, further comprising storing one or more parameters associated with said determination of said availability of said one or more content objects for said user in a temporary file on said computing device of said user, wherein said temporary file is one of utilized by said software component and accessed by said content management server for determining said availability of said one or more content objects.

7. The computer implemented method of claim 1, wherein said visual representation of said one or more content objects comprises a visual representation of said determined availability of said one or more content objects for said user.

8. The computer implemented method of claim 1, wherein said generation of said visual representation of said one or more content objects comprises creating one or more visual elements specific to one or more of said user and said computing device of said user, wherein said one or more visual elements are one of selected by said user, associated with unique user information, and associated with said characteristic information of said user.

9. The computer implemented method of claim 1, further comprising deploying one or more web components that interact with said software component on said computing device of said user for said monitoring of said characteristic information of said user.

10. The computer implemented method of claim 1, wherein said monitoring of said characteristic information of said user by said software component comprises tracking said user across one or more websites via said network using one or more of a third party temporary file and a third party application.

11. The computer implemented method of claim 1, wherein said one or more user activities performed by said user on said computing device of said user comprise a plurality of input actions of said user, content viewing behavior of said user, links accessed by said user, content displayed on said computing device of said user, and time spent by said user on said computing device and said network.

12. The computer implemented method of claim 1, further comprising displaying said acquired one or more content objects to said user on one or more interfaces of said software component configured based on one or more of said characteristic information of said user, unique user information, and visual elements selected by said user.

13. The computer implemented method of claim 1, further comprising providing interactive access of said software component to external server applications for determining, acquiring, and displaying said one or more content objects over said network.

14. The computer implemented method of claim 1, wherein said one or more actions associated with said one or more content objects, initiated by said user on said software component, comprise one or more of purchasing said one or more content objects, opting for said one or more content objects, downloading said one or more content objects, obtaining additional information on said one or more content objects from said content management server, rating said one or more content objects, and sharing said one or more content objects with one or more other users.

15. The computer implemented method of claim 1, wherein said monitoring of said characteristic information of said user by said software component is performed by logging said characteristic information on said computing device of said user.

16. The computer implemented method of claim 1, further comprising tracking said initiated delivery transaction by said transaction management server and associating said initiated delivery transaction with an identifier for analyzing said initiated delivery transaction, progress of said delivery of said reference pointer, sharing of said reference pointer between a plurality of users, and said one or more actions associated with said one or more content objects initiated by said users.

17. The computer implemented method of claim 1, further comprising acquiring marketing information associated with said one or more content objects from a plurality of external sources by said software component, wherein said software component transmits said acquired marketing information to said content management server for enabling marketing and distribution of said one or more content objects to said user.

18. The computer implemented method of claim 1, wherein said one or more content objects comprise one or more of text objects, voice objects, video objects, and multimedia objects associated with applications, content, products, and services.

19. The computer implemented method of claim 1, wherein said delivery transaction is initiated by said transaction management server using one or more short message codes.

20. A computer implemented system for determining availability of one or more content objects for a user and acquiring said one or more content objects for said user, comprising:
a software component provided on a computing device of said user, wherein said software component comprises:
a monitoring module that monitors characteristic information of said user, wherein said characteristic information of said user comprises information associated with one or more user activities performed on said computing device of said user and information associated with said computing device; and
an action initiation module that enables said user to initiate one or more actions associated with said one or more content objects on said software component using a reference pointer delivered to said computing device of said user via a content management server for acquiring said one or more content objects;
an availability determination module on one or more of said software component and said content management server, wherein said availability determination module determines availability of said one or more content objects for said user based on said characteristic information of said user and context of said software component accessible on said computing device of said user;
a content management server in communication with said software component via a network, comprising:
a visual representation generation module that generates a visual representation of said one or more content objects for said user based on said determined availability and said characteristic information of said user, wherein said user accesses said visual representation on said software component; and
a transaction management server in communication with said content management server via said network, wherein said transaction management server comprises:
a transaction module that initiates a delivery transaction that generates said reference pointer for each of said one or more content objects based on inputs provided by said user on accessing said visual representation, wherein said transaction module delivers said generated reference pointer to said computing device of said user via said content management server for enabling said user to acquire said one or more content objects.

21. The computer implemented system of claim 20, wherein said transaction management server further comprises a tracking module that tracks said initiated delivery transaction and associates said initiated delivery transaction with an identifier for analyzing said initiated delivery transaction, progress of said delivery of said reference pointer, sharing of said reference pointer between a plurality of users, and said one or more actions associated with said one or more content objects initiated by said users.

22. The computer implemented system of claim 20, wherein said availability determination module determines availability of said one or more content objects for said user using availability information and said characteristic information of said user stored in one or more of a temporary file on said computing device of said user and said content management server.

23. The computer implemented system of claim 20, wherein said software component further comprises a storage module that stores said characteristic information of said user and one or more parameters associated with said determination of said availability of said one or more content objects for said user in a temporary file on said computing device of said user, wherein said temporary file is utilized by said availability determination module on said one or more of said software component and said content management server for determining said availability of said one or more content objects.

24. The computer implemented system of claim 20, wherein said software component further comprises a graphical user interface that displays said generated visual representation and said acquired one or more content objects to said user, wherein said graphical user interface is configured based on one or more of said characteristic information of said user, unique user information, and visual elements selected by said user.

25. The computer implemented system of claim 20, wherein said visual representation generation module of said content management server creates one or more visual elements specific to one or more of said user and said computing device of said user for said generation of said visual representation of said one or more content objects, wherein said one or more visual elements are one of selected by said user, associated with unique user information, and associated with said characteristic information of said user.

26. The computer implemented system of claim 20, further comprising a mining server for generating and updating a content database in said content management server with said characteristic information of said user, information associated with said content objects, information on interactions with said content objects, and marketing information from one or more websites, wherein said content database further stores preferences associated with said one or more content objects received from said user for said generation of said reference pointer to each of said one or more content objects by said transaction module in said transaction management server.

27. The computer implemented system of claim 20, wherein said content management server further comprises an availability information database that stores availability information of a plurality of said content objects and said characteristic information of said user.

28. A computer program product comprising computer executable instructions embodied in a non-transitory computer readable storage medium, wherein said computer program product comprises:
a first computer program code for providing a software component on a computing device of a user in communication with a content management server and a transaction management server via a network;
a second computer program code for monitoring characteristic information of said user, wherein said characteristic information of said user comprises information associated with one or more user activities performed on said computing device of said user and information associated with said computing device;
a third computer program code for determining availability of one or more content objects for said user by one or more of said software component and said content management server in communication with said software component, based on said characteristic information of said user and context of said software component accessible on said computing device of said user;
a fourth computer program code for displaying a visual representation of said one or more content objects generated by said content management server for said user based on said determined availability and said characteristic information of said user, wherein said user provides inputs on accessing said visual representation to initiate a delivery transaction by said transaction management server, in communication with said content management server, to generate a reference pointer for each of said one or more content objects; and
a fifth computer program code for enabling said user to initiate one or more actions associated with said one or more content objects using said generated reference pointer delivered to said computing device of said user via said content management server for acquiring said one or more content objects.
